(19) United States
(12) Patent Application Publication
(10) Pub. No.: US 2021/0282399 A1
(43) Pub. Date: Sep. 16, 2021

(54) FUNGICIDAL COMPOSITION

(71) Applicant: Adama Makhteshim Ltd., Beer Sheva (IL)

(72) Inventors: Pedro Henrique de Castro Singer, Londrina (BR); Renato Castagna, Schaffhausen (CH)

(73) Assignee: Adama Makhteshim Ltd., Beer Sheva (IL)

(21) Appl. No.: 17/252,661

(22) PCT Filed: Jun. 19, 2019
(86) PCT No.: PCT/IB2019/055187

§ 371 Date: Dec. 15, 2020

Related U.S. Application Data
(60) Provisional application No. 62/688,028, filed on Jun. 21, 2018.

(51) Int. Cl. A01N 43/40; A01N 25/14; A01N 25/10; A01N 25/04; A01N 43/56; A01N 37/34; A01N 47/14; A01N 43/653; A01N 43/78; A01N 35/02; A01N 37/52; A01N 43/54

(52) U.S. Cl. CPC A01N 43/40; A01N 25/14; A01N 25/10; A01N 25/04; A01N 43/56; A01N 43/54; A01N 47/14; A01N 43/653; A01N 43/78; A01N 35/02; A01N 37/52; A01N 37/34

(57) ABSTRACT

The present invention relates to novel fungicidal compositions effective in combatting or preventing fungal diseases of crop plants. In particular, the invention relates to novel fungicidal mixtures and compositions comprising a combination of fenpropidin in association with at least one other fungicide. It has been found that combinations, mixtures and compositions comprising a) fenpropidin, and at least one fungicides selected from the group consisting of b) a multi-site contact fungicide, c) a strobilurin, d) a succinate dehydrogenase inhibitor (SDHI) fungicide, e) a triazole fungicide, f) a dicarboximide fungicide, g) a phenylpyrrole (PP) fungicide, h) a benzophenone fungicide, i) a phenyl acetamide fungicide, and j) a pyrimidines fungicide has a synergistically increased action on the prevention and control of fungal diseases in crop plants without causing phytotoxicity to the plants. A method for treating plant or soil against fungal infection is also disclosed.

### CROSS-REFERENCE TO RELATED APPLICATIONS

This application is a § 371 national stage of PCT International Application No. PCT/IB2019/055187, filed Jun. 19, 2019, claiming the benefit of U.S. Provisional Application No. 62/688,028, filed Jun. 21, 2018, the contents of each of which are hereby incorporated by reference herein.

Throughout this application, various publications are cited. Disclosures of the documents and publications referred to herein are hereby incorporated in their entireties by reference into this application.

### FIELD OF THE PRESENT SUBJECT MATTER

The present invention relates to novel fungicidal compositions effective in combatting or preventing fungal diseases of crop plants. In particular the invention relates to novel fungicidal compositions comprising a combination of fenpropidin in association with at least one other fungicide. A method for controlling or preventing fungal diseases in crop plants is also disclosed.

### BACKGROUND OF THE INVENTION

Fungicides are compounds of natural or synthetic origin which act to protect plants against damage caused by fungi. In spite of the benefits derived from the use of fungicides in agriculture such as protection of crops and improved productivity, it is nowadays desirable to reduce the amount of fungicides used in the fields owing to the potential health risks associated with an intensive use of agrochemicals.

In addition, repeated usage of a single fungicide often leads to the development of resistance to the fungicide.

Another important issue associated with fungus attacks is the loss of nutrients which leads to a decrease in the overall yield of the crop. One of the most damaging diseases affecting the yield of leguminous plants causing widespread damage to crops is the Asian Soybean Rust. Compositions comprising one single active ingredient have shown a limited control over the disease. There is therefore a need for a composition and method of treatment that provides a control over the fungal attacks on crops and enables higher yields while preserving a high amount of nutrients in crops.

Fenpropidin is mainly a cereal fungicide. The chemical name for fenpropidin is (±)-1-[3-[4-(1,1-dimethylethyl)phenyl]-2-methylpropyl]piperidine, and its structure may be represented as:

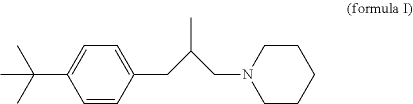 [SMILES: CC(Cc1ccc(C(C)(C)C)cc1)CN1CCCCC1]

The limited application of fenpropidin is due to its phytotoxicity to plants.

Resistance of fungus is worldwide problem. Many known fungicides are less effective and there is a need to revert and restore their activity.
In addition, Phakopsora pachyrhizi is an important fungus which cause to foliar diseases of soybean worldwide. Phakopsora pachyrhizi was found to have resistance to many fungicides and is a challenging pathogen to control.
There is a need to develop a new method and mixture for treating Phakopsora pachyrhizi fungus.

### SUMMARY OF THE PRESENT SUBJECT MATTER

Provided is a fungicidal composition comprising a combination of a) fenpropidin mixed in certain ratios with at least one of the fungicides on the following list: b) a multi-site contact fungicide; c) and/or a strobilurin fungicide; d) and/or a succinate dehydrogenase inhibitor (SDHI) fungicide; e) and/or a triazole fungicide.

Also provided is a method of combatting phytopathogenic diseases on crop plants, which comprises applying to the crop plant or to the locus thereof the fungicide composition.

The present invention also provides a combination comprising (a) an amount of fenpropidin, and an amount of at least one additional fungicide selected from the group consisting of:
(b) a multi-site contact fungicide,
(c) a strobilurin fungicide,
(d) a succinate dehydrogenase inhibitor (SDHI) fungicide,
(e) a triazole fungicide,
(f) a dicarboxamide fungicide,
(g) a phenylpyrrole (PP) fungicide,
(h) a benzophenone fungicide,
(i) a phenyl acetamide fungicide, and
(j) a pyrimidines fungicide,
   wherein the amount of fenpropidin and the amount of the additional fungicide(s) when applied together is more effective in treating a plant or soil against fungal infection than when each fungicide at the same amount is applied alone.

The combination of the present invention can be a mixture.

The mixture of the present invention can be a synergistic mixture.

The present invention also provides a fungicidal composition comprising any one of the combinations or mixtures disclosed herein.

The present invention also provides a method of treating a plant or soil against fungal infection comprising applying an effective amount of any one of the combinations, mixtures or compositions disclosed herein to the plant, propagation material of the plant, or soil so as to thereby treat the plant or soil against fungal infection.

The present invention also provides a method of treating a plant or soil against fungal infection comprising applying to the plant, propagation material of the plant, or soil (a) an amount of fenpropidin, and an amount of at least one additional fungicide selected from the group consisting of:
(b) a multi-site contact fungicide,
(c) a strobilurin fungicide,
(d) a succinate dehydrogenase inhibitor (SDHI) fungicide,
(e) a triazole fungicide,
(f) a dicarboxamide fungicide,
(g) a phenylpyrrole (PP) fungicide,
(h) a benzophenone fungicide,
(i) a phenyl acetamide fungicide, and
(j) a pyrimidines fungicide,
   so as to thereby treat the plant or soil against fungal infection,
   wherein the amount of fenpropidin and the amount of the additional fungicide(s) when applied together is more effective for treating the plant or soil against fungal infection than when each fungicide at the same amount is applied alone.

The present invention also provides a method of treating a plant or soil against fungal infection comprising applying to the plant, propagation material of the plant, or soil (a) an amount of fenpropidin, and an amount of at least one additional fungicide selected from the group consisting of:
(b) a multi-site contact fungicide,
(c) a strobilurin fungicide,
(d) a succinate dehydrogenase inhibitor (SDHI) fungicide,
(e) a triazole fungicide,
(f) a dicarboxamide fungicide,
(g) a phenylpyrrole (PP) fungicide,
(h) a benzophenone fungicide,
(i) a phenyl acetamide fungicide, and
(j) a pyrimidines fungicide,
   so as to thereby treat the plant or soil against fungal infection,
   wherein the amount of fenpropidin applied is less than the fungicidally effective amount of fenpropidin when fenpropidin is used alone, and/or
   wherein the amount of the additional fungicide(s) applied is less than the fungicidally effective amount of the additional fungicide(s) when the additional fungicide(s) is used alone.

The present invention also provides use of any one of the combinations, mixtures or compositions disclosed herein for combatting phytopathogenic diseases on crop plants.

The present invention also provides use of any one of the combinations, mixtures or compositions disclosed herein for treating a plant or soil against fungal infection.

The present invention also provides a method of treating a plant or soil against infection by Phakopsora pachyrhizi comprising applying an amount of fenpropidin to the plant, propagation material of the plant, or soil so as to thereby treat the plant or soil against infection by Phakopsora pachyrhizi.

The present invention also provides a method of treating a plant or soil against Asian soybean rust comprising applying an amount of fenpropidin to the plant, propagation material of the plant, or soil so as to thereby treat the plant or soil against Asian soybean rust.

The present invention also provides use of fenpropidin for combatting phytopathogenic diseases on crop plants.

The present invention also provides use of fenpropidin for treating a plant or soil against infection by Phakopsora pachyrhizi.

The present invention also provides use of fenpropidin for treating a plant or soil against Asian soybean rust.

The present invention also provides a package comprising any one of the combinations, mixtures or compositions disclosed herein.

The present invention also provides a process for the preparation any one of the combinations, mixtures or compositions disclosed herein from individual component parts.

### BRIEF DESCRIPTION OF THE DRAWINGS

FIG. 1 is a graphical representation of the comparative data showing the fungicidal efficacy of fenpropidin, cyprodinil and thifluzamide for controlling soybean rust at various rates of application.

FIG. 2 is a pictorial representation of the fungicidal efficacy of fenpropidin, cyprodinil and thifluzamide for controlling soybean rust at various rates of application.

FIG. 3 is a graphical representation of the comparative data showing the fungicidal efficacy of various two-way fenpropidin mixtures for controlling soybean rust.

FIG. 4 is a graphical representation of the comparative data showing the effect of various two-way fenpropidin mixtures on soybean yield.

FIG. 5 is a graphical representation of the comparative data showing the fungicidal efficacy of various three-way fenpropidin mixtures for controlling soybean rust.

FIG. 6 is a graphical representation of the comparative data showing the effect of various three-way fenpropidin mixtures on soybean yield.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below to explain aspects of the present disclosure.

As used herein, the term “and/or” includes any and all combinations of one or more of the associated listed items. Expressions such as “at least one of,” when preceding a list of elements, modify the entire list of elements and do not modify the individual elements of the list.

It will be understood that when an element is referred to as being “on” another element, it can be directly in contact with the other element or intervening elements may be present therebetween. In contrast, when an element is referred to as being “directly on” another element, there are no intervening elements present.

It will be understood that, although the terms first, second, third, etc., may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present embodiments.

The terminology used herein is for the purpose of describing particular embodiments only and is not intended to be limiting. As used herein, the singular forms “a,” “an,” and “the” are intended to include the plural forms as well, unless the context clearly indicates otherwise.

The term “or” means “and/or.” It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

“About” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

As used herein, the term “combination” means an assemblage of agrochemicals for application either by simultaneous or contemporaneous application.

As used herein, the term “simultaneous” when used in connection with application of agrochemicals means that the agrochemicals are applied in an admixture, for example, a tank mix. For simultaneous application, the combination may be the admixture or separate containers each containing an agrochemical that are combined prior to application.

As used herein, the term “contemporaneous” when used in connection with application of agrochemicals means that an individual agrochemical is applied separately from another agrochemical or premixture at the same time or at times sufficiently close together that a synergistic activity or an activity that is additive or more than additive relative to the activity of either agrochemical alone at the same dose is achieved.

As used herein, the term “effective” when used in connection with an amount of the combination, mixture or composition refers to an amount of the combination, mixture or composition that achieve a good level of control of the fungus, pathogen, and/or disease when applied to a plant, propagation material of the plant, or soil.

As used herein, the term “fungicidally effective amount” refers to an amount of the active component that is commercially recommended for use to control fungi. The commercially recommended amount for each active component, often specified as application rates of the commercial formulation, may be found on the label accompanying the commercial formulation. The commercially recommended application rates of the commercial formulation may vary depending on factors such as the plant species and the fungus to be controlled.

As used herein, the term “treating a plant or soil against fungal infection” includes, but is not limited to, protecting the plant or soil against fungal attack, preventing fungal infection of the plant or soil, controlling fungal disease infecting the plant or soil, and reducing fungal infection of the plant or soil.

As used herein, the term “more effective for controlling fungal disease” includes, but is not limited to, increasing efficacy of fungal disease control and reducing the amount of time needed to achieve a given level of fungal control.

As used herein, the term “more effective for protecting the plant or soil against fungal attack” includes, but is not limited to, prolonging the duration of protection against fungal attack after application and extending the protection period against fungal attack.

Surprisingly, it has now been found that a composition comprising a combination of a) fenpropidin, when mixed in certain ratios with at least one of the fungicides on the following list:
b) a multi-site contact fungicide
c) and/or a strobilurin
d) and/or a SDHI fungicide (Succinate Dehydrogenase Inhibitors)
e) and/or a triazole fungicide,
   has a synergistically increased action on the control of fungal diseases in crop plants without causing phytotoxicity to the plants. A particular advantage of the composition according to the present invention is that this synergistic effect among the active components allows for a reduction of the total amount of fungicide used on the crops while still having a good control of fungal diseases.

Surprisingly, it has now been found that a combination comprising a) fenpropidin and at least one fungicide selected from the group consisting of:
b) a multi-site contact fungicide
c) a strobilurin fungicide,
d) a SDHI fungicide,
e) a triazole fungicide,
f) a dicarboximide fungicide,
(g) a phenylpyrrole (PP) fungicide,
(h) a benzophenone fungicide,
(i) a phenyl acetamide fungicide, and
(j) a pyrimidines fungicide,
   has an increased action on protecting plant or soil against fungal attack, preventing fungal infection of plant or soil, controlling fungal disease infecting plant or soil, and reducing fungal infection of plant or soil without causing phytotoxicity to the plant. The increased action can be a synergistically increased action. A particular advantage of the combination according to the present invention is that this synergistic effect among the active components allows for a reduction of the total amount of fungicide used on the plant or soil while still having a good effect of treating the plant or soil against fungal infection.

Synergism occurs when the effect of two or more compounds exceeds the effect of the compounds when used alone.

It has also been found that these combinations help prevent fungal attack and thus enables the use of a reduced amount of fungicides at a later stage of the plant development. The present combination is capable of containing or destroying the microorganisms which occur on plants or parts of plants (fruits, flowers, foliage, stalks, tubers, roots) of a variety of crops of useful plants, and even on parts of plants which are formed at a later point in time and remain unharmed by such microorganisms.

Additionally, in order to solve one of the problems encountered in the state of the art, the present invention developed a method for reducing the phytotoxicity of fenpropidin on crops, in particular on soybean crops. Although fenpropidin is a fungicide commonly used in the control of fungal diseases on soybean crops, they are also causing more toxic effect on plants (phytotoxicity) even at normal doses used for the control of diseases. It has now been found that fenpropidin when mixed with at least one of the active ingredients b), c), d) and/or e) shows a clearly reduced phytotoxicity.

One particularly advantageous method according to the invention consists in: 1) adding to the spray tank fenpropidin in an amount lying in the range of from 50 g of active ingredient per hectare (50 g a.i./ha) to 2000 g a.i./ha, preferably from 150 g a.i./ha to 1000 g a.i./ha, more preferably from 300 g a.i./ha to 850 g a.i./ha, even more preferably from 150 g a.i./ha to 350 g a.i./ha together with at least one of the active ingredients b), c), d) and/or e) as well as the adjuvants; 2) triggering the spray tank agitator; and 3) once the mixture is homogenized, applying the mixture on the crop.

The combinations according to the invention may also comprise more than one of the active components b), c), d), e), if broadening of the spectrum of disease control is desired.

The present invention also provides a combination comprising (a) an amount of fenpropidin, and an amount of at least one additional fungicide selected from the group consisting of:
(b) a multi-site contact fungicide,
(c) a strobilurin fungicide,
(d) a succinate dehydrogenase inhibitor (SDHI) fungicide,
(e) a triazole fungicide,
(f) a dicarboxamide fungicide,
(g) a phenylpyrrole (PP) fungicide,
(h) a benzophenone fungicide,
(i) a phenyl acetamide fungicide, and
(j) a pyrimidines fungicide.

The present invention also provides a synergistic combination comprising (a) an amount of fenpropidin, and an amount of at least one additional fungicide selected from the group consisting of:
(b) a multi-site contact fungicide,
(c) a strobilurin fungicide,
(d) a succinate dehydrogenase inhibitor (SDHI) fungicide,
(e) a triazole fungicide,
(f) a dicarboxamide fungicide,
(g) a phenylpyrrole (PP) fungicide,
(h) a benzophenone fungicide,
(i) a phenyl acetamide fungicide, and
(j) a pyrimidines fungicide.

The present invention also provides a combination comprising (a) an amount of fenpropidin, and an amount of at least one additional fungicide selected from the group consisting of:
(b) a multi-site contact fungicide,
(c) a strobilurin fungicide,
(d) a succinate dehydrogenase inhibitor (SDHI) fungicide,
(e) a triazole fungicide,
(f) a dicarboxamide fungicide,
(g) a phenylpyrrole (PP) fungicide,
(h) a benzophenone fungicide,
(i) a phenyl acetamide fungicide, and
(j) a pyrimidines fungicide,
   wherein the combination is more effective for treating a plant or soil against fungal disease than when each fungicide at the same amount is applied alone.

The present invention also provides a combination comprising (a) an amount of fenpropidin, and an amount of at least one additional fungicide selected from the group consisting of:
(b) a multi-site contact fungicide,
(c) a strobilurin fungicide,
(d) a succinate dehydrogenase inhibitor (SDHI) fungicide,
(e) a triazole fungicide,
(f) a dicarboxamide fungicide,
(g) a phenylpyrrole (PP) fungicide,
(h) a benzophenone fungicide,
(i) a phenyl acetamide fungicide, and
(j) a pyrimidines fungicide,
   wherein the amount of fenpropidin and the amount of the additional fungicide(s) when applied together is more effective in treating a plant or soil against fungal infection than when each fungicide at the same amount is applied alone.

The present invention also provides a combination comprising (a) an amount of fenpropidin, and an amount of at least one additional fungicide selected from the group consisting of:
(b) a multi-site contact fungicide,
(c) a strobilurin fungicide,
(d) a succinate dehydrogenase inhibitor (SDHI) fungicide,
(e) a triazole fungicide,
(f) a dicarboxamide fungicide,
(g) a phenylpyrrole (PP) fungicide,
(h) a benzophenone fungicide,
(i) a phenyl acetamide fungicide, and
(j) a pyrimidines fungicide,
   wherein the amount of fenpropidin in the mixture is less than the fungicidally effective amount of fenpropidin when fenpropidin is used alone, and/or
   wherein the amount of the additional fungicide(s) in the mixture is less than the fungicidally effective amount of the additional fungicide(s) when the additional fungicide(s) is used alone.

In some embodiments, the combination is a mixture. In some embodiments, the mixture is a tank mix. In some embodiments, the mixture is synergistic.

The present invention also provides a mixture comprising (a) an amount of fenpropidin, and an amount of at least one additional fungicide selected from the group consisting of:
(b) a multi-site contact fungicide,
(c) a strobilurin fungicide,
(d) a succinate dehydrogenase inhibitor (SDHI) fungicide,
(e) a triazole fungicide,
(f) a dicarboxamide fungicide,
(g) a phenylpyrrole (PP) fungicide,
(h) a benzophenone fungicide,
(i) a phenyl acetamide fungicide, and
(j) a pyrimidines fungicide,
   wherein the mixture is more effective for treating a plant or soil against fungal disease than when each fungicide at the same amount is applied alone.

The present invention also provides a mixture comprising (a) an amount of fenpropidin, and an amount of at least one additional fungicide selected from the group consisting of:
(b) a multi-site contact fungicide,
(c) a strobilurin fungicide,
(d) a succinate dehydrogenase inhibitor (SDHI) fungicide,
(e) a triazole fungicide,
(f) a dicarboxamide fungicide,
(g) a phenylpyrrole (PP) fungicide,
(h) a benzophenone fungicide,
(i) a phenyl acetamide fungicide, and
(j) a pyrimidines fungicide,
   wherein the amount of fenpropidin and the amount of the additional fungicide(s) when applied together is more effective for treating a plant or soil against fungal infection than when each fungicide at the same amount is applied alone.

The present invention also provides a mixture comprising (a) an amount of fenpropidin, and an amount of at least one additional fungicide selected from the group consisting of:
(b) a multi-site contact fungicide,
(c) a strobilurin fungicide,
(d) a succinate dehydrogenase inhibitor (SDHI) fungicide,
(e) a triazole fungicide,
(f) a dicarboxamide fungicide,
(g) a phenylpyrrole (PP) fungicide,
(h) a benzophenone fungicide,
(i) a phenyl acetamide fungicide, and
(j) a pyrimidines fungicide,
   wherein the amount of fenpropidin in the mixture is less than the fungicidally effective amount of fenpropidin when fenpropidin is used alone, and/or
   wherein the amount of the additional fungicide(s) in the mixture is less than the fungicidally effective amount of the additional fungicide(s) when the additional fungicide(s) is used alone.

The mixture of the present invention can be a synergistic mixture.

The present invention also provides a fungicidal composition comprising any one of the combinations or mixtures disclosed herein.

In some embodiments, the combination, mixture or composition comprises a multi-site contact fungicide. In some embodiments, the amount of the multi-site contact fungicide in the mixture is less than the fungicidally effective amount of the multi-site contact fungicide when the multi-site contact fungicide is used alone.

In some embodiments, the combination, mixture or composition comprises a strobilurin fungicide. In some embodiments, the amount of the strobilurin fungicide in the mixture is less than the fungicidally effective amount of the strobilurin fungicide when the strobilurin fungicide is used alone.

In some embodiments, the combination, mixture or composition comprises a SDHI fungicide. In some embodiments, the amount of the SDHI fungicide in the mixture is less than the fungicidally effective amount of the SDHI fungicide when the SDHI fungicide is used alone.

In some embodiments, the combination, mixture or composition comprises a triazole fungicide. In some embodiments, the amount of the triazole fungicide in the mixture is less than the fungicidally effective amount of the triazole fungicide when the triazole fungicide is used alone.

In some embodiments, the combination, mixture or composition comprises a dicarboximide fungicide. In some embodiments, the amount of the dicarboximide fungicide in the mixture is less than the fungicidally effective amount of the dicarboximide fungicide when the dicarboximide fungicide is used alone.

In some embodiments, the combination, mixture or composition comprises a phenylpyrrole (PP) fungicide. In some embodiments, the amount of the PP fungicide in the mixture is less than the fungicidally effective amount of the PP fungicide when the PP fungicide is used alone.

In some embodiments, the combination, mixture or composition comprises a benzophenone fungicide. In some embodiments, the amount of the benzophenone fungicide in the mixture is less than the fungicidally effective amount of the benzophenone fungicide when the benzophenone fungicide is used alone.

In some embodiments, the combination, mixture or composition comprises a phenyl acetamide fungicide. In some embodiments, the amount of the phenyl acetamide fungicide in the mixture is less than the fungicidally effective amount of the phenyl acetamide fungicide when the phenyl acetamide fungicide is used alone.

In some embodiments, the combination, mixture or composition comprises a pyrimidines fungicide. In some embodiments, the amount of the pyrimidines fungicide in the mixture is less than the fungicidally effective amount of the pyrimidines fungicide when the pyrimidines fungicide is used alone.

In some embodiments, the combination, mixture or composition is more effective for treating the plant or soil against fungal infection than each fungicide at the same amount is applied alone.

In some embodiments, the combination, mixture or composition is more effective for protecting the plant or soil against fungal attack infection than when each fungicide at the same amount is applied alone. In some embodiments, the combination, mixture or composition is more effective for preventing fungal infection of the plant or soil infection than when each fungicide at the same amount is applied alone. In some embodiments, the combination, mixture or composition is more effective for controlling fungal disease infecting the plant or soil infection than when each fungicide at the same amount is applied alone. In some embodiments, the combination, mixture or composition is more effective for reducing fungal infection of the plant or soil infection than when each fungicide at the same amount is applied alone.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than when fenpropidin at the same amount is applied alone.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than when the multi-site contact fungicide at the same amount is applied alone.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than when the strobilurin fungicide at the same amount is applied alone.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than when the SDHI fungicide at the same amount is applied alone.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than when the triazole fungicide at the same amount is applied alone.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than when the dicarboxamide fungicide at the same amount is applied alone.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than when the PP fungicide at the same amount is applied alone.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than when the benzophenone fungicide at the same amount is applied alone.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than when the phenyl acetamide fungicide at the same amount is applied alone.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than when the pyrimidines fungicide at the same amount is applied alone.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than fenpropidin when used at its fungicidally effective amount.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than the multi-site contact fungicide when used at its fungicidally effective amount.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than the strobilurin fungicide when used at its fungicidally effective amount.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than the SDHI fungicide when used at its fungicidally effective amount.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than the triazole fungicide when used at its fungicidally effective amount.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than the dicarboxamide fungicide when used at its fungicidally effective amount.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than the PP fungicide when used at its fungicidally effective amount.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than the benzophenone fungicide when used at its fungicidally effective amount.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than the phenyl acetamide fungicide when used at its fungicidally effective amount.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than the pyrimidines fungicide when used at its fungicidally effective amount.

The multi-site contact fungicide contained in the composition according to the invention inhibits fungal growth through multiple sites of action. The term contact fungicide as used herein denotes a fungicide that remains at the site where it is applied but does not travel within the plant. This fungicide may be selected from the group consisting of copper, sulfur, anilazine, dithianon, captan, captafol, folpet, febram, mancozeb, zinc thiazole, chlorothalonil, maneb, propineb, metiram, thiram, zineb, ziram or a mixture thereof. Preferably the multi-site contact fungicide contained in the composition according to the invention is selected from the group consisting of mancozeb, copper, chlorothalonil or a mixture thereof.

In some embodiments, the multi-site contact fungicide is selected from the group consisting of copper, sulfur, anilazine, dithianon, captan, captafol, folpet, febram, mancozeb, zinc thiazole, chlorothalonil, maneb, propineb, metiram, thiram, zineb, ziram, and any mixture thereof.

In some embodiments, the multi-site contact fungicide is chlorothalonil. In some embodiments, the multi-site contact fungicide is copper oxychloride. In some embodiments, the contact fungicide is copper hydroxide. In some embodiments, the multi-site contact fungicide is fluazinam. In some embodiments, the multi-site contact fungicide is captan. In some embodiments, the multi-site contact fungicide is folpet.

The strobilurin fungicide contained in the composition according to the invention is part of the larger group of QoI inhibitors (quinone outside inhibitors), which act to inhibit the respiratory chain at the level of Complex III. Strobilurin fungicides have a suppressive effect on fungi, reducing competition for nutrients; they inhibit electron transfer in mitochondria, disrupting metabolism and preventing growth of the target fungi. The strobilurin fungicide contained in the composition according to the invention may be selected from the group consisting of azoxystrobin, kresoxim-methyl, picoxystrobin, fluxastrobin, oryzastrobin, dimoxystrobin, pyraclostrobin and trifloxystrobin, enoxastrobin, pyraclostrobin, mandestrobin, flufenostrin, coumoxystrobin, metominostrobin, fenaminstrobin, pyrametostrobin, or a mixture thereof. Preferably, the strobilurin is picoxystrobin.

In some embodiments, the strobilurin fungicide is selected from the group consisting of azoxystrobin, kresoxim-methyl, picoxystrobin, fluxastrobin, oryzastrobin, dimoxystrobin, pyraclostrobin and trifloxystrobin, enoxastrobin, pyraclostrobin, mandestrobin, flufenostrin, coumoxystrobin, metominostrobin, fenaminstrobin, pyrametostrobin, and any mixture thereof. In some embodiments, the strobilurin fungicide is picoxystrobin. In some embodiments, the strobilurin fungicide is azoxystrobin.

The SDHI (succinate dehydrogenase inhibitors) fungicide contained in the composition according to the invention may be selected from the group consisting of fluxapyroxad, penflufen, furametpyr, bixafen, isopyrazam, sedaxane, benzovindiflupyr, thifluzamide, isofetamid, fluopyram, pydiflumetofen, pyraziflumid, benodanil, mepronil, flutolanil, fenfuram, oxycarboxin, carboxin, boscalid, quinofumelin, fluindapyr or a mixture thereof. Preferably, the SDHI fungicide is fluxapyroxad.

In some embodiments, the SDHI fungicide is selected from the group consisting of fluxapyroxad, penflufen, furametpyr, bixafen, isopyrazam, sedaxane, benzovindiflupyr, thifluzamide, isofetamid, fluopyram, pydiflumetofen, pyraziflumid, benodanil, mepronil, flutolanil, fenfuram, oxycarboxin, carboxin, boscalid, quinofumelin, fluindapyr, and any mixture thereof. In some embodiments, the SDHI fungicide is fluxapyroxad. In some embodiments, the SDHI fungicide is bixafen. In some embodiments, the SDHI fungicide is benzovindiflupyr. In some embodiments, the SDHI fungicide is boscalid. In some embodiments, the SDHI fungicide is thifluzamide. In some embodiments, the SDHI fungicide is penthiopyrad.

The triazole fungicide contained in the composition according to the invention may be selected from the group consisting of azaconazole, etaconazole, ipconazole, tebuconazole, metconazole, fenbuconazole, bitertanol, bromuconazole, fluquinconazole, myclobutanil, tetraconazole, flusilazole, cyproconazole, flutriafol, penconazole, triadimenol, difenoconazole, hexaconazole, simeconazole, prothioconazole, imibenconazole, diniconazole, epoxiconazole or a mixture thereof. The preferred triazole fungicide is prothioconazole.

In some embodiments, the triazole fungicide is selected from the group consisting of azaconazole, etaconazole, ipconazole, tebuconazole, metconazole, fenbuconazole, bitertanol, bromuconazole, fluquinconazole, myclobutanil, tetraconazole, flusilazole, cyproconazole, flutriafol, penconazole, triadimenol, difenoconazole, hexaconazole, simeconazole, prothioconazole, imibenconazole, diniconazole, epoxiconazole, and any mixture thereof. In some embodiments, the triazole fungicide is prothioconazole. In some embodiments, the triazole fungicide is hexaconazole. In some embodiments, the triazole fungicide is tebuconazole. In some embodiments, the triazole fungicide is tetraconazole. In some embodiments, the triazole fungicide is difenoconazole.

In some embodiments, the dicarboximide fungicide is selected from the group consisting of vinclozolin, iprodione, procymidone, chlozolinate and any mixture thereof. In some embodiments, the dicarboximide fungicide is iprodione.

In some embodiments, the PP fungicide is selected from the group consisting of fenpiclonil, fludioxonil and any mixture thereof. In some embodiments, the PP fungicide is fludioxonil.

In some embodiments, the benzophenone fungicide is metrafenone.

In some embodiments, the phenyl acetamide fungicide is cyflufenamid.

In some embodiments, the pyrimidines fungicide is selected from the group consisting of bupirimate, dimethirimol, ethirimol and any mixture thereof. In some embodiments, the pyrimidines fungicide is bupirimate.

In some embodiments, the combination, mixture or composition comprises one additional fungicide.

The present invention also provides a synergistic mixture comprising (a) an amount of fenpropidin, and an amount of at least one additional fungicide selected from the group consisting of:
(b) a multi-site contact fungicide selected from group consisting of copper, sulfur, anilazine, dithianon, captan, captafol, folpet, febram, mancozeb, zinc thiazole, chlorothalonil, maneb, propineb, metiram, thiram, zineb, ziram or a mixture thereof,
(c) a strobilurin fungicide selected from group consisting of azoxystrobin, kresoxim-methyl, picoxystrobin, fluxastrobin, oryzastrobin, dimoxystrobin, pyraclostrobin and trifloxystrobin, enoxastrobin, pyraclostrobin, mandestrobin, flufenostrin, coumoxystrobin, metominostrobin, fenaminstrobin, pyrametostrobin, or a mixture thereof,
(d) a succinate dehydrogenase inhibitor (SDHI) fungicide selected from group consisting of fluxapyroxad, penflufen, furametpyr, bixafen, isopyrazam, sedaxane, benzovindiflupyr, thifluzamide, isofetamid, fluopyram, pydiflumetofen, pyraziflumid, benodanil, mepronil, flutolanil, fenfuram, oxycarboxin, carboxin, boscalid, quinofumelin, fluindapyr or a mixture thereof,
(e) a triazole fungicide selected from group consisting of azaconazole, etaconazole, ipconazole, tebuconazole, metconazole, fenbuconazole, bitertanol, bromuconazole, fluquinconazole, myclobutanil, tetraconazole, flusilazole, cyproconazole, flutriafol, penconazole, triadimenol, difenoconazole, hexaconazole, simeconazole, prothioconazole, imibenconazole, diniconazole, epoxiconazole or a mixture thereof,
(f) a dicarboxamide fungicide selected from group consisting of vinclozolin, iprodione, procymidone, chlozolinate, and any mixture thereof,
(g) a phenylpyrrole (PP) fungicide selected from group consisting of fenpiclonil, fludioxonil and any mixture thereof,
(h) a benzophenone fungicide,
(i) a phenyl acetamide fungicide, and
(j) a pyrimidines fungicide.

The present invention also provides a mixture comprising (a) an amount of fenpropidin, and an amount of at least one additional fungicide selected from the group consisting of:
(b) a multi-site contact fungicide selected from group consisting of copper, sulfur, anilazine, dithianon, captan, captafol, folpet, febram, mancozeb, zinc thiazole, chlorothalonil, maneb, propineb, metiram, thiram, zineb, ziram or a mixture thereof,
(c) a strobilurin fungicide selected from group consisting of azoxystrobin, kresoxim-methyl, picoxystrobin, fluxastrobin, oryzastrobin, dimoxystrobin, pyraclostrobin and trifloxystrobin, enoxastrobin, pyraclostrobin, mandestrobin, flufenostrin, coumoxystrobin, metominostrobin, fenaminstrobin, pyrametostrobin, or a mixture thereof,
(d) a succinate dehydrogenase inhibitor (SDHI) fungicide selected from group consisting of fluxapyroxad, penflufen, furametpyr, bixafen, isopyrazam, sedaxane, benzovindiflupyr, thifluzamide, isofetamid, fluopyram, pydiflumetofen, pyraziflumid, benodanil, mepronil, flutolanil, fenfuram, oxycarboxin, carboxin, boscalid, quinofumelin, fluindapyr or a mixture thereof,
(e) a triazole fungicide selected from group consisting of azaconazole, etaconazole, ipconazole, tebuconazole, metconazole, fenbuconazole, bitertanol, bromuconazole, fluquinconazole, myclobutanil, tetraconazole, flusilazole, cyproconazole, flutriafol, penconazole, triadimenol, difenoconazole, hexaconazole, simeconazole, prothioconazole, imibenconazole, diniconazole, epoxiconazole or a mixture thereof,
(f) a dicarboxamide fungicide selected from group consisting of vinclozolin, iprodione, procymidone, chlozolinate, and any mixture thereof,
(g) a phenylpyrrole (PP) fungicide selected from group consisting of fenpiclonil, fludioxonil and any mixture thereof,
(h) a benzophenone fungicide,
(i) a phenyl acetamide fungicide, and
(j) a pyrimidines fungicide,
   wherein the mixture is more effective for treating a plant or soil against fungal infection than when each fungicide at the same amount is applied alone.

The present invention also provides a mixture comprising (a) an amount of fenpropidin, and an amount of at least two additional fungicides selected from the group consisting of:
(b) a multi-site contact fungicide,
(c) a strobilurin fungicide,
(d) a succinate dehydrogenase inhibitor (SDHI) fungicide,
(e) a triazole fungicide,
(f) a dicarboxamide fungicide,
(g) a phenylpyrrole (PP) fungicide,
(h) a benzophenone fungicide,
(i) a phenyl acetamide fungicide, and
(j) a pyrimidines fungicide,
   wherein the amount of fenpropidin and the amount of the additional fungicides when applied together is more effective for treating a plant or soil against fungal attack than when each fungicide at the same amount is applied alone.

The present invention also provides a mixture comprising (a) fenpropidin, and at least two additional fungicides selected from the group consisting of:
(b) a multi-site contact fungicide,
(c) a strobilurin fungicide,
(d) a succinate dehydrogenase inhibitor (SDHI) fungicide,
(e) a triazole fungicide,
(f) a dicarboxamide fungicide,
(g) a phenylpyrrole (PP) fungicide,
(h) a benzophenone fungicide,
(i) a phenyl acetamide fungicide, and
(j) a pyrimidines fungicide,
   wherein the amount of fenpropidin in the mixture is less than the fungicidally effective amount of fenpropidin when fenpropidin is used alone, and/or
   wherein the amount of the additional fungicide(s) in the mixture is less than the fungicidally effective amount of the additional fungicide(s) when the additional fungicide(s) is used alone.

The present invention also provides a mixture comprising (a) an amount of fenpropidin, and an amount of at least one additional fungicide selected from the group consisting of:
(b) a multi-site contact fungicide,
(c) a strobilurin fungicide,
(d) a succinate dehydrogenase inhibitor (SDHI) fungicide
(e) a triazole fungicide,
(f) a dicarboxamide fungicide,
(g) a phenylpyrrole (PP) fungicide,
(h) a benzophenone fungicide,
(i) a phenyl acetamide fungicide, and
(j) a pyrimidines fungicide,
   wherein the mixture is more effective for treating a plant or soil against fungal attack than when each fungicide at the same amount is applied alone.

The present invention also provides a mixture for controlling crop disease, the mixture comprising (a) fenpropidin, and at least one additional fungicide selected from the group consisting of:
(b) a multi-site contact fungicide,
(c) a strobilurin fungicide,
(d) a succinate dehydrogenase inhibitor (SDHI) fungicide,
(e) a triazole fungicide,
(f) a dicarboxamide fungicide,
(g) a phenylpyrrole (PP) fungicide,
(h) a benzophenone fungicide,
(i) a phenyl acetamide fungicide, and
(j) a pyrimidines fungicide,
   wherein the crop disease is Asian soybean rust.

The present invention also provides a mixture for controlling fungus, the mixture comprising (a) fenpropidin, and at least one additional fungicide selected from the group consisting of:
(b) a multi-site contact fungicide,
(c) a strobilurin fungicide,
(d) a succinate dehydrogenase inhibitor (SDHI) fungicide,
(e) a triazole fungicide,
(f) a dicarboxamide fungicide,
(g) a phenylpyrrole (PP) fungicide,
(h) a benzophenone fungicide,
(i) a phenyl acetamide fungicide, and
(j) a pyrimidines fungicide,
   wherein the fungus is Phakopsora pachyrhizi

The present invention also provides a mixture for controlling Asian soybean rust, the mixture comprising (a) fenpropidin, and at least one additional fungicide selected from the group consisting of:
(b) a multi-site contact fungicide,
(c) a strobilurin fungicide,
(d) a succinate dehydrogenase inhibitor (SDHI) fungicide,
(e) a triazole fungicide,
(f) a dicarboxamide fungicide,
(g) a phenylpyrrole (PP) fungicide,
(h) a benzophenone fungicide,
(i) a phenyl acetamide fungicide, and
(j) a pyrimidines fungicide.

The present invention also provides a mixture for controlling Phakopsora pachyrhizi, the mixture comprising (a) fenpropidin, and at least one additional fungicide selected from the group consisting of:
(b) a multi-site contact fungicide,
(c) a strobilurin fungicide,
(d) a succinate dehydrogenase inhibitor (SDHI) fungicide,
(e) a triazole fungicide,
(f) a dicarboxamide fungicide,
(g) a phenylpyrrole (PP) fungicide,
(h) a benzophenone fungicide,
(i) a phenyl acetamide fungicide, and
(j) a pyrimidines fungicide.

Specific compositions according to the invention are: fenpropidin and mancozeb, fenpropidin and copper, fenpropidin and chlorothalonil; fenpropidin and picoxystrobin; fenpropidin and fluxapyroxad.

The most preferred combinations according to the invention are fenpropidin with fluxapyroxad and mancozeb; fenpropidin with fluxapyroxad and copper; fenpropidin with fluxapyroxad and chlorothalonil; fenpropidin with fluxapyroxad and picoxystrobin.

In some embodiments, the combination, mixture or composition comprises fenpropidin and mancozeb. In some embodiments, the combination, mixture or composition comprises fenpropidin and chlorothalonil. In some embodiments, the combination, mixture or composition comprises fenpropidin and copper oxychloride. In some embodiments, the combination, mixture or composition comprises fenpropidin and copper hydroxide. In some embodiments, the combination, mixture or composition comprises fenpropidin and fluazinam. In some embodiments, the combination, mixture or composition comprises fenpropidin and captan. In some embodiments, the combination, mixture or composition comprises fenpropidin and folpet.

In some embodiments, the combination, mixture or composition comprises fenpropidin and fluxapyroxad. In some embodiments, the combination, mixture or composition comprises fenpropidin and bixafen. In some embodiments, the combination, mixture or composition comprises fenpropidin and benzovindiflupyr. In some embodiments, the combination, mixture or composition comprises fenpropidin and boscalid. In some embodiments, the combination, mixture or composition comprises fenpropidin and thifluzamide.

In some embodiments, the combination, mixture or composition comprises fenpropidin and picoxystrobin. In some embodiments, the combination, mixture or composition comprises fenpropidin and azoxystrobin.

In some embodiments, the combination, mixture or composition comprises fenpropidin and prothioconazole. In some embodiments, the combination, mixture or composition comprises fenpropidin and hexaconazole. In some embodiments, the combination, mixture or composition comprises fenpropidin and tebuconazole. In some embodiments, the combination, mixture or composition comprises fenpropidin and tetraconazole. In some embodiments, the combination, mixture or composition comprises fenpropidin and difenoconazole.

In some embodiments, the combination, mixture or composition comprises fenpropidin and iprodione.

In some embodiments, the combination, mixture or composition comprises fenpropidin and fludioxonil.

In some embodiments, the combination, mixture or composition comprises fenpropidin and metraphenone.

In some embodiments, the combination, mixture or composition comprises fenpropidin and cyflufenamid.

In some embodiments, the combination, mixture or composition comprises fenpropidin and bupirimate.

The combination according to the invention may also comprise more than one of the active components b), c), d) and/or e), if broadening the spectrum of the disease control is desired.

In some embodiments, the combination, mixture or composition comprises two additional fungicides.

In some embodiments, the combination, mixture or composition comprises fenpropidin, mancozeb and fluxapyroxad. In some embodiments, the combination, mixture or composition comprises fenpropidin, mancozeb and picoxystrobin. In some embodiments, the combination, mixture or composition comprises fenpropidin, mancozeb and azoxystrobin. In some embodiments, the combination, mixture or composition comprises fenpropidin, mancozeb and prothioconazole. In some embodiments, the combination, mixture or composition comprises fenpropidin, mancozeb and tebuconazole. In some embodiments, the combination, mixture or composition comprises fenpropidin, chlorothalonil and fluxapyroxad. In some embodiments, the combination, mixture or composition comprises fenpropidin, chlorothalonil and azoxystrobin. In some embodiments, the combination, mixture or composition comprises fenpropidin, chlorothalonil and picoxystrobin. In some embodiments, the combination, mixture or composition comprises fenpropidin, fluxapyroxad and picoxystrobin. In some embodiments, the combination, mixture or composition comprises fenpropidin, fluxapyroxad and prothioconazole. In some embodiments, the combination, mixture or composition comprises fenpropidin, prothioconazole and picoxystrobin. In some embodiments, the combination, mixture or composition comprises fenpropidin, tebuconazole and picoxystrobin. In some embodiments, the combination, mixture or composition comprises fenpropidin, picoxystrobin and copper oxychloride. In some embodiments, the combination, mixture or composition comprises fenpropidin, azoxystrobin and copper oxychloride. In some embodiments, the combination, mixture or composition comprises fenpropidin, fluxapyroxad, and copper oxychloride. In some embodiments, the combination, mixture or composition comprises fenpropidin, azoxystrobin, and copper hydroxide. In some embodiments, the combination, mixture or composition comprises fenpropidin, fluxapyroxad, and copper hydroxide. In some embodiments, the combination, mixture or composition comprises fenpropidin, prothioconazole and copper hydroxide. In some embodiments, the combination, mixture or composition comprises fenpropidin, tebuconazole and copper hydroxide. In some embodiments, the combination, mixture or composition comprises fenpropidin, azoxystrobin and boscalid. In some embodiments, the combination, mixture or composition comprises fenpropidin, copper hydroxide and boscalid.

In some embodiments, the combination, mixture or composition comprises three additional fungicides.

In some embodiments, the combination, mixture or composition comprises fenpropidin, a multi-site contact fungicide, a triazole fungicide and a strobilurin fungicide. In some embodiments, the combination, mixture or composition comprises fenpropidin, mancozeb, tebuconazole and picoxystrobin.

In some embodiments, the combination, mixture or composition comprises fenpropidin, a multisite-contact fungicide, a triazole fungicide and a SDHI fungicide.

In some embodiments, the mixture is a tank mix.

The amount of combination of the invention to be applied, will depend on various factors such as the compound employed, the subject of the treatment (plant, soil, seed), the type of treatment (e.g. spraying, dusting, seed dressing), the purpose of the treatment (prophylactic or therapeutic), the type of fungi to be treated and the application time.

In a preferred embodiment, in the fungicidal composition according to the invention, the weight ratio of a) to b) and/or c) and/or d) and/or a) to e) lies in the range of from 10:1 to 1:10.

In another embodiment, in the fungicidal composition according to the invention, the weight ratio of a) to b) and/or c) and/or d) and/or a) to e) lies in the range of from 5:1 to 1:5.

In yet another embodiment, in the fungicidal composition according to the invention, the weight ratio of a) to b) and/or c) and/or d) and/or a) to e) lies in the range of from 2:1 to 1:1.

In some embodiments, the weight ratio of a) to b) and/or c) and/or d) and/or a) to e) in the combination, mixture or composition lies in the range of from 10:1 to 1:10. In some embodiments, the weight ratio of a) to b) and/or c) and/or d) and/or e) and/or f) and/or g) and/or h) and/or i) and/or j) in the combination, mixture or composition lies in the range of from 10:1 to 1:10.

In some embodiments, the weight ratio of a) to b) and/or c) and/or d) and/or a) to e) in the combination, mixture or composition lies in the range of from 5:1 to 1:5. In some embodiments, the weight ratio of a) to b) and/or c) and/or d) and/or e) and/or f) and/or g) and/or h) and/or i) and/or j) in the combination, mixture or composition lies in the range of from 5:1 to 1:5.

In some embodiments, the weight ratio of a) to b) and/or c) and/or d) and/or a) to e) in the combination, mixture or composition lies in the range of from 2:1 to 1:1. In some embodiments, the weight ratio of a) to b) and/or c) and/or d) and/or e) and/or f) and/or g) and/or h) and/or i) and/or j) in the combination, mixture or composition lies in the range of from 2:1 to 1:1.

In some embodiments, the weight ratio of fenpropidin to the multi-site contact fungicide is from 1:25 to 8:5. In some embodiments, the weight ratio of fenpropidin to the multi-site contact fungicide is from 1:15 to 1:5. In some embodiments, the weight ratio of fenpropidin to the multi-site contact fungicide is from 1:25 to 4:10. In some embodiments, the weight ratio of fenpropidin to the multi-site contact fungicide is from 1:2 to 1:5. In some embodiments, the weight ratio of fenpropidin to the multi-site contact fungicide is from 1:15 to 8:5. In some embodiments, the weight ratio of fenpropidin to the multi-site contact fungicide is from 1:25 to 8:10. In some embodiments, the weight ratio of fenpropidin to the multi-site contact fungicide is about 1:6.

In some embodiments, the weight ratio of fenpropidin to the SDHI fungicide is 2:1 to 5:1. In some embodiments, the weight ratio of fenpropidin to the SDHI fungicide is 5:9 to 40:3. In some embodiments, the weight ratio of fenpropidin to the SDHI fungicide is 10:3 to 20:3. In some embodiments, the weight ratio of fenpropidin to the SDHI fungicide is 4:9 to 40:3. In some embodiments, the weight ratio of fenpropidin to the SDHI fungicide is 4:7 to 8:5. In some embodiments, the weight ratio of fenpropidin to the SDHI fungicide is 4:1.

In some embodiments, the weight ratio of fenpropidin to the strobilurin fungicide is 5:3 to 5:1.

In some embodiments, the weight ratio of fenpropidin to the triazole fungicide is 2:5 to 16:1. In some embodiments, the weight ratio of fenpropidin to the triazole fungicide is 10:2 to 5:7. In some embodiments, the weight ratio of fenpropidin to the triazole fungicide is 20:3 to 10:3. In some embodiments, the weight ratio of fenpropidin to the triazole fungicide is 4:3.

In some embodiments, the weight ratio of fenpropidin to mancozeb is 1-2:10-15. In some embodiments, the weight ratio of fenpropidin to mancozeb is about 1:6. In some embodiments, the weight ratio of fenpropidin to chlorothalonil is 1-4:10-25. In some embodiments, the weight ratio of fenpropidin to copper oxychloride is 1-2:5. In some embodiments, the weight ratio of fenpropidin to copper hydroxide is 1-2:5. In some embodiments, the weight ratio of fenpropidin to fluxapyroxad is 2-5:1. In some embodiments, the weight ratio of fenpropidin to fluxapyroxad is 4:1. In some embodiments, the weight ratio of fenpropidin to bixafen is 5-40:3-9. In some embodiments, the weight ratio of fenpropidin to benzovindiflypyr is 10-20:3. In some embodiments, the weight ratio of fenpropidin to picoxystrobin is 5:3-1. In some embodiments, the weight ratio of fenpropidin to azoxystrobin is 5:3-1. In some embodiments, the weight ratio of fenpropidin to prothioconazole is 10-5:7-2. In some embodiments, the weight ratio of fenpropidin to hexaconazole is 20-10:3. In some embodiments, the weight ratio of fenpropidin to tebuconazole is 4:3. In some embodiments, the weight ratio of fenpropidin to tetraconazole is 2-16:1-5. In some embodiments, the weight ratio of fenpropidin to fluazinam is 1-8:5-15. In some embodiments, the weight ratio of fenpropidin to captan is 1-8:10-25. In some embodiments, the weight ratio of fenpropidin to folpet is 1-8:10-25. In some embodiments, the weight ratio of fenpropidin to boscalid is 4-40:3-9. In some embodiments, the weight ratio of fenpropidin to thifluzamide is 4-8:7-5.

In some embodiments, the weight ratio of fenpropidin to the dicarboximide fungicide is 2-4:5.

In some embodiments, the weight ratio of fenpropidin to iprodione is 2-4:5.

In some embodiments, the weight ratio of fenpropidin to the PP fungicide is 2-4:5.

In some embodiments, the weight ratio of fenpropidin to fludioxonil is 2-4:5.

In some embodiments, the weight ratio of fenpropidin to the benzophenone fungicide is 1:10 to 10:1. In some embodiments, the weight ratio of fenpropidin to the benzophenone fungicide is 2-4:5.

In some embodiments, the weight ratio of fenpropidin to the phenyl acetamide fungicide is 1:10 to 10:1. In some embodiments, the weight ratio of fenpropidin to the phenyl acetamide fungicide is 2-4:5.

In some embodiments, the weight ratio of fenpropidin to the pyrimidines fungicide is 1:10 to 10:1. In some embodiments, the weight ratio of fenpropidin to the pyrimidines fungicide is 2-4:5.

In some embodiments, the weight ratio of fenpropidin to the multi-site contact fungicide to the SDHI fungicide is 2-10:20-60:1-3. In some embodiments, the weight ratio of fenpropidin to the multi-site contact fungicide to the SDHI fungicide is 4:22.5:1. In some embodiments, the weight ratio of fenpropidin to the multi-site contact fungicide to the strobilurin fungicide is 5:50-30:3-2. In some embodiments, the weight ratio of fenpropidin to the multi-site contact fungicide to the triazole fungicide is 2-5:20-30:1-2. In some embodiments, the weight ratio of fenpropidin to the multi-site contact fungicide to the triazole fungicide is 4-8:40-48:3-5. In some embodiments, the weight ratio of fenpropidin to the first multi-site contact fungicide to the second multi-site contact fungicide is 2-20:20-125:1-6. In some embodiments, the weight ratio of fenpropidin to the multi-site contact fungicide to the SDHI fungicide is 5-20:50-125:3-8. In some embodiments, the weight ratio of fenpropidin to the multi-site contact fungicide to the strobilurin fungicide is 5-20:50-125:3-8. In some embodiments, the weight ratio of fenpropidin to the multi-site contact fungicide to the strobilurin fungicide is 10:5-3:6-3. In some embodiments, the weight ratio of fenpropidin to the SDHI fungicide to the triazole fungicide is 2-10:1-3:1-4. In some embodiments, the weight ratio of fenpropidin to the triazole fungicide to the strobilurin fungicide is 10-5:5-2:6-2. In some embodiments, the weight ratio of fenpropidin to the triazole fungicide to the strobilurin fungicide is 20-40:15-25:12-60. In some embodiments, the weight ratio of fenpropidin to the strobilurin fungicide to the multi-site contact fungicide is 5-10:3-2:25. In some embodiments, the weight ratio of fenpropidin to the SDHI fungicide to the multi-site contact fungicide is 2-10:1-2:5-25. In some embodiments, the weight ratio of fenpropidin to the strobilurin fungicide to the multi-site contact fungicide is 10:6-2:25. In some embodiments, the weight ratio of fenpropidin to the SDHI fungicide to the multi-site contact fungicide is 2-10:1-2:5-25. In some embodiments, the weight ratio of fenpropidin to the triazole fungicide to the multi-site contact fungicide is 10-20:7-8:25-75. In some embodiments, the weight ratio of fenpropidin to the triazole fungicide to the multi-site contact fungicide is 4-8:3-5:10-40. In some embodiments, the weight ratio of fenpropidin to the strobilurin fungicide to the SDHI fungicide is 20-40:12-8:15-9. In some embodiments, the weight ratio of fenpropidin to the multi-site contact fungicide to the SDHI fungicide is 4-40:20-100:3-9.

In some embodiments, the weight ratio of fenpropidin to mancozeb to fluxapyroxad is 2-10:20-60:1-3. In some embodiments, the weight ratio of fenpropidin to mancozeb to fluxapyroxad is 4:22.5:1. In some embodiments, the weight ratio of fenpropidin to mancozeb to picoxystrobin is 5:50-30-3:2. In some embodiments, the weight ratio of fenpropidin to mancozeb to azoxystrobin is 5:50-30:3-2. In some embodiments, the weight ratio of fenpropidin to mancozeb to prothioconazole is 2-5:20-30:1-2. In some embodiments, the weight ratio of fenpropidin to mancozeb to tebuconazole is 4-8:40-48:3-5. In some embodiments, the weight ratio of fenpropidin to chlorothalonil to fluxapyroxad is 2-20:20-125:1-6. In some embodiments, the weight ratio of fenpropidin to chlorotalonil to azoxystrobin is 5-20:50-125:3-8. In some embodiments, the weight ratio of fenpropidin to chlorothalonil to picoxystrobin is 5-20:50-125:3-8. In some embodiments, the weight ratio of fenpropidin to fluxapyroxad to picoxystrobin is 10:5-3:6-3. In some embodiments, the weight ratio of fenpropidin to fluxapyroxad to prothioconazole is 2-10:1-3:1-4. In some embodiments, the weight ratio of fenpropidin to prothioconazole to picoxystrobin is 10-5:5-2:6-2. In some embodiments, the weight ratio of fenpropidin to tebuconazole to picoxystrobin is 20-40:15-25:12-60. In some embodiments, the weight ratio of fenpropidin to picoxystrobin to copper oxychloride is 5-10:3-2:25. In some embodiments, the weight ratio of fenpropidin to azoxystrobin to copper oxychloride is 5-10:3-2:25. In some embodiments, the weight ratio of fenpropidin to fluxapyroxad to copper oxychloride is 2-10:1-2:5-25. In some embodiments, the weight ratio of fenpropidin to azoxystrobin to copper hydroxide is 10:6-2:25. In some embodiments, the weight ratio of fenpropidin to fluxapyroxad to copper hydroxide is 2-10:1-2:5-25. In some embodiments, the weight ratio of fenpropidin to prothioconazole to copper hydroxide is 10-20:7-8:25-75. In some embodiments, the weight ratio of fenpropidin to tebuconazole to copper hydroxide is 4-8:3-5:10-40. In some embodiments, the weight ratio of fenpropidin to azoxystrobin to boscalid is 20-40:12-8:15-9. In some embodiments, the weight ratio of fenpropidin to copper hydroxide to boscalid is 4-40:20-100:3-9.

In some embodiments, the mixture comprises fenpropidin and picoxystrobin, wherein the weight ratio of fenpropidin to picoxystrobin is 1:3. In some embodiments, the mixture comprises fenpropidin, fluxapyroxad and mancozeb, wherein the weight ratio of fenpropidin to fluxapyroxad and mancozeb is 1:5. In some embodiments, the mixture comprises fenpropidin, fluxapyroxad and chlorothalonil, wherein the weight ratio of fenpropidin to fluxapyroxad and chlorothalonil is 1:3. In some embodiments, the mixture comprises fenpropidin and mancozeb wherein the weight ratio of fenpropidin to mancozeb is 1:2.

In some embodiments, the weight ratio of fenpropidin to benzophenone fungicide is 5:1-1:5. In some embodiments, the weight ratio of fenpropidin to benzophenone fungicide is about 3:1.

In some embodiments, the weight ratio of fenpropidin to the phenyl acetamide fungicide is 30:1 to 10:1. In some embodiments, the weight ratio of fenpropidin to the phenyl acetamide fungicide is about 24:1

In some embodiments, the weight ratio of fenpropidin to the difenoconazole is 0.8-1.2:1

In some embodiments, the combination, mixture or composition is more effective for protecting a plant from fungal attack, preventing fungal infection of the plant or soil, controlling fungal disease infecting the plant or soil, and/or reducing fungal infection of the plant or soil than the pyrimidines fungicide when used at its fungicidally effective amount.

In some embodiments, the combination, mixture or composition is more effective for controlling fungal diseases than when each fungicide at the same amount is applied alone.

In some embodiments, the combination, mixture or composition increases efficacy of fungal control compared to when each fungicide at the same amount is applied alone.

In some embodiments, the combination, mixture or composition reduces the amount of time needed to achieve a level of fungal control compared to when each fungicide at the same amount is applied alone. For example, if each fungicide applied alone achieves 50% control of fungal disease 7 days after application, the combination, mixture or composition disclosed herein achieves 50% control of fungal diseases 2 days after application where each fungicide is applied at the rate.

In some embodiments, the amount of time is reduced by at least 1 day, 2 days, 3 days, 4 day, 5 days, 7 days, 10 days, 14 days or 21 days, or 28 days.

In some embodiments, the combination, mixture or composition is more effective for protecting the plant or soil against fungal attack than when each fungicide at the same amount is applied alone.

In some embodiments, the combination, mixture or composition prolongs protection against the fungus compared to when each fungicide at the same amount is applied alone.

In some embodiments, protection is prolonged by at least 7 days, 14 day, 21 days, or 28 day.

In some embodiments, the combination, mixture or composition disclosed herein extends the protection period against fungal attack compared to when each fungicide at the same amount is applied alone.

In some embodiments, the protection period is extended by at least 7 days, 14 days, 21 days, or 28 days.

In some embodiments, the combination, mixture or composition is effective for increasing plant development compared to when each fungicide at the same amount is applied alone. Increasing plant development includes, but is not limited to, enhancing the root systems, enhancing shoot of the crop plant, enhancing plant vigor and/or enhancing plant potential yield.

In some embodiments, plant vigor is assessed using the relative vigor index. In some embodiments, plant vigor is increased by at least 1%, 5%, 10, 20%, 30%, 40%, 50%, 60%, 70%, 80%, or 90%.

In some embodiments, enhancement in root system is measured by root weight. In some embodiments, root weight is increased by at least 1%, 5%, 10, 20%, 30%, 40%, 50%, 60%, 70%, 80%, or 90%.

In some embodiments, enhancement in shoot is measured by shoot weight. In some embodiments, shoot weight is increased by at least 1%, 5%, 10, 20%, 30%, 40%, 50%, 60%, 70%, 80%, or 90%.

In some embodiments, the combination, mixture, or composition disclosed herein has synergistic effect.

The present invention also provides a fungicidal composition comprising any one of the combinations or mixtures disclosed herein.

In some embodiments, the fungicidal composition further comprises at least one agrochemically acceptable carrier. Suitable carriers are described in detail below.

Preferably, in the fungicidal composition according to the invention, the combination of a) fenpropidin mixed with b) and/or c) and/or d) and/or e) represents 0.5 wt % to 95 wt % of the total weight of the fungicide composition.

In some embodiments, the amount of fenpropidin and b) and/or c) and/or d) and/or e) represents 0.5 wt % to 95 wt % of the total weight of the combination, mixture, or composition. In some embodiments, the amount of fenpropidin and b) and/or c) and/or d) and/or e) and/or f) and/or g) and/or h) and/or i) and/or j) represents 0.5 wt % to 95 wt % of the total weight of the combination, mixture, or composition.

The present invention also provides a water dispersible granules composition comprising:
(a) 15 wt % of fenpropidin and picoxystrobin, wherein the weight ratio of fenpropidin to picoxystrobin is 1:3,
(b) 5 wt % of sodium lignosulfonate,
(c) 3 wt % of sodium laurylsulfate,
(d) 6 wt % of sodium diisobutylnaphthalene-sulfonate,
(e) 2 wt % of octylphenol polyethylene glycol ether (7-8 mol of ethylene oxide),
(f) 10 wt % of highly disperse silica, and
(g) 59 wt % of kaolin.

The present invention also provides an emulsion concentrate composition comprising:
(a) 10 wt % of fenpropidin, fluxapyroxad and mancozeb, wherein the weight ratio of fenpropidin to fluxapyroxad and mancozeb is 1:5,
(b) 3 wt % of octylphenol polyethylene glycol ether (4-5 mol of ethylene oxide),
(c) 3 wt % of calcium dodecylbenzenesulfonate,
(d) 4 wt % of castor oil polyglycol ether (35 mol of ethylene oxide),
(e) 30 wt % of cyclohexanone, and
(f) 50 wt % of xylene.

The present invention also provides a coated granules composition comprising:
(a) 8 wt % of fenpropidin, fluxapyroxad and chlorothalonil, wherein the weight ratio of fenpropidin to fluxapyroxad and chlorthalonil is 1:3,
(b) 3 wt % of polyethylene glycol (MW 200), and
(c) 89 wt % of kaolin.

The present invention also provides a suspension concentrate composition comprising:
(a) 40 wt % of fenpropidin and mancozeb, wherein the weight ratio of fenpropidin to mancozeb is 1:2,
(b) 10 wt % of propylene glycol,
(c) 6 wt % of nonylphenol polyethylene glycol ether (15 mol of ethylene oxide),
(d) 10 wt % of sodium lignosulfonate,
(e) 1 wt % of carboxymethylcellulose,
(f) 1 wt % of silicone oil (in the form of a 75% aqueous emulsion), and
(g) 32 wt % of water.

The present invention also discloses a method of combatting phytopathogenic diseases on crop plants which comprises applying to the crop plant or to the locus thereof the fungicide composition according to the invention. A preferred method of applying the invention composition comprises the application of said composition to the aerial parts of the plant, especially the foliage (foliar application).

The present invention also discloses a method of combatting phytopathogenic diseases on crop plants which comprises applying to the crop plant or to the locus thereof the combination, mixture or composition according to the invention. A preferred method of applying the invention combination, mixture or composition comprises the application of said combination, mixture or composition to the aerial parts of the plant, especially the foliage (foliar application).

The present invention also provides a method of treating a plant or soil against fungal infection comprising applying an effective amount of any one of the combinations, mixtures, or compositions disclosed herein to the plant, propagation material of the plant, or soil so as to thereby treat the plant or soil against fungal infection.

The present invention also provides a method of protecting a plant or soil from fungal attack comprising applying an effective amount of any one of the combinations, mixtures, or compositions disclosed herein to the plant, propagation material of the plant, or soil so as to thereby protect the plant or soil from fungal attack.

The present invention also provides a method of preventing fungal infection of a plant or soil comprising applying an effective amount of any one of the combinations, mixtures, or compositions disclosed herein to the plant, propagation material of the plant, or soil so as to thereby prevent fungal infection of the plant or soil.

The present invention also provides a method of controlling fungal disease infecting a plant or soil comprising applying an effective amount of any one of the combinations, mixtures, or compositions disclosed herein to the plant, propagation material of the plant, or soil so as to thereby control the fungal disease infecting the plant or soil.

The present invention also provides a method of reducing fungal infection of a plant or soil comprising applying an effective amount of any one of the combinations, mixtures, or compositions disclosed herein to the plant, propagation material of the plant, or soil so as to thereby reduce fungal infection of the plant or soil.

The present invention also provides a method for prolonging the period of protection against fungal infection comprising applying any one of the combinations, mixtures or compositions disclosed herein to a plant or soil.

In some embodiments, the method comprises applying fenpropidin and the additional fungicide(s) at any one of the rates described herein.

The rate at which the fungicidal composition according to the invention is applied will depend upon the particular type of fungus to be controlled, the degree of control required and the timing and method of application. In general, the composition of the disclosure can be applied at an application rate lying in the range of from about 25 grams of total active ingredient per hectare (g a.i./ha) to about 2000 g a.i./ha based on the total amount of active ingredients in the composition.

In an embodiment, the fungicidal composition according to the invention is applied at a rate lying in the range of from about 60 g a.i./ha to about 600 g a.i./ha. In a more particular embodiment, the fungicidal composition according to the invention is applied at a rate lying in the range of from about 100 g a.i./ha to about 200 g a.i./ha, even more particularly in the range of from about 100 g a.i./ha to about 130 g a.i./ha.

The rate at which the combination, mixture or composition according to the invention is applied will depend upon the particular type of fungus to be controlled, the degree of control required and the timing and method of application. In some embodiments, the combination, mixture or composition is applied at a rate from about 25 grams of total active ingredient per hectare (g a.i./ha) to about 2000 g a.i./ha based on the total amount of active ingredients in the combination, mixture or composition.

In some embodiments, the combination, mixture or composition is applied at a rate from about 60 g a.i./ha to about 600 g a.i./ha. In some embodiments, the combination, mixture or composition is applied at a rate from about 100 g a.i./ha to about 200 g a.i./ha. In some embodiments, the combination, mixture or composition is applied at a rate from about 100 g a.i./ha to about 130 g a.i./ha.

The components of the combination, mixture or composition of the present disclosure can be applied either separately or as part of a multipart fungicidal system. The components of the combination, mixture or composition of the present disclosure can be applied either separately or as part of a multipart fungicidal system. Consequently, the methods and uses disclosed herein include preparation of the combination, mixture and composition from the component parts prior to application or use.

In some embodiments, the components of the combination, mixture or composition are applied simultaneous.

In some embodiments, the components of the combination, mixture or composition are applied contemporaneously.

In some embodiments, the fenpropidin and/or mixture thereof is applied at least one time during a growth season.

In some embodiments, the fenpropidin and/or mixture thereof is applied two or more times during a growth season.

In some embodiments, the fenpropidin and/or mixture thereof described herein are applied as a soil application. In some embodiments, the mixtures and/or compositions described herein are applied as a foliar application.

In some embodiments, the combination, mixture or composition is applied at least one time during a growth season.

In some embodiments, the combination, mixture or composition is applied two or more times during a growth season.

In some embodiments, the combination, mixture or composition described herein are applied as a soil application. In some embodiments, the combination, mixture or composition described herein are applied as a foliar application.

The rate at which the combination, mixture or composition disclosed herein is applied will depend upon the particular type of fungus to be controlled, the degree of control required and the timing and method of application. In general, the combination, mixture or composition described herein can be applied at an application rate of between about 60 grams per hectare (g/ha) and about 2600 g/ha.

In some embodiments, the fenpropidin is applied at a rate between 10-400 g a.i./ha. In some embodiments, the fenpropidin is applied at a rate between 30-400 g a.i./ha. In some embodiments, the fenpropidin is applied at a rate between 100-400 g a.i./ha. In some embodiments, the fenpropidin is applied at a rate of 300 g a.i./ha. In some embodiments, the fenpropidin is applied at a rate of 250 g a.i./ha. In some embodiments, the fenpropidin is applied at a rate between 50-200 g a.i./ha. In some embodiments, the fenpropidin is applied at a rate between 100-200 g a.i./ha. In some embodiments, the fenpropidin is applied at a rate of less than 200 g a.i./ha. In some embodiments, the fenpropidin is applied at a rate of 200 g a.i./ha. In some embodiments, the fenpropidin is applied at a rate of 150 g a.i./ha. In some embodiments, the fenpropidin is applied at a rate of 100 g a.i./ha. In some embodiments, the fenpropidin is applied at a rate of 75 g a.i./ha. In some embodiments, the fenpropidin is applied at a rate of 30 g a.i./ha.

In some embodiments, the multi-site contact fungicide is applied at a rate of 100-2000 g a.i./ha. In some embodiments, the multi-site contact fungicide is applied at a rate of 500-1500 g a.i./ha. In some embodiments, the multi-site contact fungicide is applied at a rate of 1000-1500 g a.i./ha. In some embodiments, the multi-site contact fungicide is applied at a rate of 1000-1200 g a.i./ha. In some embodiments, the multi-site contact fungicide is applied at a rate of 1125 g a.i./ha. In some embodiments, the multi-site contact fungicide is applied at a rate of 1000 g a.i./ha. In some embodiments, the multi-site contact fungicide is applied at a rate of 1000-1250 g a.i./ha. In some embodiments, the multi-site contact fungicide is applied at a rate of 250-1000 g a.i./ha. In some embodiments, the multi-site contact fungicide is applied at a rate of 500-1000 g a.i./ha. In some embodiments, the multi-site contact fungicide is applied at a rate of 250-750 g a.i./ha. In some embodiments, the multi-site contact fungicide is applied at a rate of 500-750 g a.i./ha.

In some embodiments, the mancozeb is applied at a rate of 800-1500 g a.i./ha. In some embodiments, the mancozeb is applied at a rate of 900 g a.i./ha. In some embodiments, the mancozeb is applied at a rate of 1000-1500 g a.i./ha. In some embodiments, the mancozeb is applied at a rate of 1000-1200 g a.i./ha. In some embodiments, the mancozeb is applied at a rate of 1125 g a.i./ha. In some embodiments, the chlorotalonil is applied at a rate of 1000-1250 g a.i./ha. In some embodiments, the chlorotalonil is applied at a rate of 1000 g a.i./ha. In some embodiments, the copper oxychloride is applied at a rate of 250-1000 g a.i./ha. In some embodiments, the copper oxychloride is applied at a rate of 500-1000 g a.i./ha. In some embodiments, the copper hydroxide is applied a rate of 250-1000 g a.i./ha. In some embodiments, the copper hydroxide is applied a rate of 500-1000 g a.i./ha. In some embodiments, the copper hydroxide is applied a rate of 250-750 g a.i./ha. In some embodiments, the fluazinam is applied at a rate of 500-750 g a.i./ha. In some embodiments, the captan is applied at a rate of 1000-1250 g a.i./ha. In some embodiments, the folpet is applied at a rate of 1000-1250 g a.i./ha.

In some embodiments, the SDHI fungicide is applied at a rate of 10-250 g a.i./ha. In some embodiments, the SDHI fungicide is applied at a rate of 30-200 g a.i./ha. In some embodiments, the SDHI fungicide is applied at a rate of 50-80 g a.i./ha. In some embodiments, the SDHI fungicide is applied at a rate of 50-60 g a.i./ha. In some embodiments, the SDHI fungicide is applied at a rate of 60-90 g a.i./ha. In some embodiments, the SDHI fungicide is applied at a rate of 30-60 g a.i./ha. In some embodiments, the SDHI fungicide is applied at a rate of 75-90 g a.i./ha. In some embodiments, the SDHI fungicide is applied at a rate of 100-250 g a.i./ha. In some embodiments, the SDHI fungicide is applied at a rate of 100-200 g a.i./ha. In some embodiments, the SDHI fungicide is applied at a rate of 175-200 g a.i./ha. In some embodiments, the SDHI fungicide is applied at a rate of 120 g a.i./ha. In some embodiments, the SDHI fungicide is applied at a rate of 180 g a.i./ha. In some embodiments, the SDHI fungicide is applied at a rate of 240 g a.i./ha. In some embodiments, the SDHI fungicide is applied at a rate of 15 g a.i./100 L.

In some embodiments, the fluxapyroxad is applied at a rate of 50-80 g a.i./ha. In some embodiments, the fluxapyroxad is applied at a rate of 50-60 g a.i./ha. In some embodiments, the bixafen is applied at a rate of 60-90 g a.i./ha. In some embodiments, the benzovindiflupyr is applied at a rate of 30-60 g a.i./ha. In some embodiments, the boscalid is applied at a rate of 75-90 g a.i./ha. In some embodiments, the thifluxamide is applied at a rate of 100-200 g a.i./ha. In some embodiments, the thifluxamide is applied at a rate of 100-250 g a.i./ha. In some embodiments, the thifluxamide is applied at a rate of 175-200 g a.i./ha. In some embodiments, the thifluxamide is applied at a rate of 120 g a.i./ha. In some embodiments, the thifluxamide is applied at a rate of 180 g a.i./ha. In some embodiments, the thifluxamide is applied at a rate of 240 g a.i./ha. In some embodiments, the penthiopyrad is applied at a rate of 15 g a.i./100 L

In some embodiments, the strobilurin fungicide is applied at a rate of 10-130 g a.i./ha. In some embodiments, the strobilurin fungicide is applied at a rate of 60-80 g a.i./ha. In some embodiments, the strobilurin fungicide is applied at a rate of 60 g a.i./ha.

In some embodiments, the picoxystrobin is applied at a rate of 60-80 g a.i./ha. In some embodiments, the picoxystrobin is applied at a rate of 60 g a.i./ha. In some embodiments, the azoxystrobin is applied at a rate of 60-80 g a.i./ha.

In some embodiments, the triazole fungicide is applied at a rate of 5-175 g a.i./ha. In some embodiments, the triazole fungicide is applied at a rate of 15-150 g a.i./ha. In some embodiments, the triazole fungicide is applied at a rate of 50-80 g a.i./ha. In some embodiments, the triazole fungicide is applied at a rate of 70-80 g a.i./ha. In some embodiments, the triazole fungicide is applied at a rate of 80 g a.i./ha. In some embodiments, the triazole fungicide is applied at a rate of 15-60 g a.i./ha. In some embodiments, the triazole fungicide is applied at a rate of 75-150 g a.i./ha. In some embodiments, the triazole fungicide is applied at a rate of 75-125 g a.i./ha. In some embodiments, the triazole fungicide is applied at a rate of 75 g a.i./ha. In some embodiments, the triazole fungicide is applied at a rate of 125 g a.i./ha. In some embodiments, the triazole fungicide is applied at a rate of 50-125 g a.i./ha. In some embodiments, the triazole fungicide is applied at a rate of 6.25 g a.i./100 L.

In some embodiments, the prothioconazole is applied at a rate of 50-80 g a.i./ha. In some embodiments, the prothioconazole is applied at a rate of 70-80 g a.i./ha. In some embodiments, the prothioconazole is applied at a rate of 80 g a.i./ha. In some embodiments, the hexaconazole is applied at a rate of 15-60 g a.i./ha. In some embodiments, the tebuconazole is applied at a rate of 75-125 g a.i./ha. In some embodiments, the tebuconazole is applied at a rate of 75-150 g a.i./ha. In some embodiments, the tebuconazole is applied at a rate of 75 g a.i./ha. In some embodiments, the tebuconazole is applied at a rate of 75-125 g a.i./ha. In some embodiments, the tetraconazole is applied at a rate of 50-125 g a.i./ha. In some embodiments, the difenoconazole is applied at a rate of 125 g a.i./ha. In some embodiments, the difenoconazole is applied at a rate of 6.25 g a.i./100 L.

In some embodiments, the dicarboximide fungicide is applied at a rate of 250-500 g a.i./ha.

In some embodiments, the iprodione is applied at a rate of 25-500 g a.i./ha.

In some embodiments, the PP fungicide is applied at a rate of 250-500 g a.i./ha.

In some embodiments, the fludioxonil is applied at a rate of 250-500 g a.i./ha.

In some embodiments, the benzophenone fungicide is applied at a rate of 50-150 g a.i./ha. In some embodiments, the benzophenone fungicide is applied at a rate of 10 g a.i./100 L. In some embodiments, the benzophenone fungicide is applied at a rate of 100 g a.i./ha.

In some embodiments, the metraphenone is applied at a rate of 10 g a.i./100 L. In some embodiments, the metraphenone is applied at a rate of 100 g a.i./ha.

In some embodiments, the phenyl acetamide fungicide is applied at a rate of 1-10 g a.i./100 L. In some embodiments, the phenyl acetamide fungicide is applied at a rate of 5 g a.i./100 L. In some embodiments, the phenyl acetamide fungicide is applied at a rate of 1.25 g a.i./100 L. In some embodiments, the phenyl acetamide fungicide is applied at a rate of 1-50 g a.i./ha. In some embodiments, the phenyl acetamide fungicide is applied at a rate of 12.5 g a.i./ha.

In some embodiments, the cyflufenamid is applied at a rate of 1.25 g a.i./100 L. In some embodiments, the cyflufenamid is applied at a rate of 5 g a.i./100 L. In some embodiments, the cyflufenamid is applied at a rate of 12.5 g a.i./ha.

In some embodiments, the pyrimidines fungicide is applied at a rate of 50-200 g a.i./ha. In some embodiments, the pyrimidines fungicide is applied at a rate of 100-150 g a.i./ha. In some embodiments, the pyrimidines fungicide is applied at a rate of 15 g a.i./100 L. In some embodiments, the pyrimidines fungicide is applied at a rate of 150 g a.i./ha. In some embodiments, the pyrimidines fungicide is applied at a rate of 100 g a.i./ha.

In some embodiments, the bupirimate is applied at a rate of 15 g a.i./100 L. In some embodiments, the bupirimate is applied at a rate of 150 g a.i./ha. In some embodiments, the bupirimate is applied at a rate of 100 g a.i./ha.

In some embodiments, the fenpropidin is applied at a rate between 0.0001 to 0.5 ppm. In some embodiments, the fenpropidin is applied at a rate between 0.0005 to 0.3 ppm. In some embodiments, the fenpropidin is applied at a rate of about 0.0005 ppm. In some embodiments, the fenpropidin is applied at a rate of about 0.002 ppm. In some embodiments, the fenpropidin is applied at a rate of about 0.06 ppm. In some embodiments, the fenpropidin is applied at a rate of about 0.3 ppm.

In some embodiments, the multi-site contact fungicide is applied at a rate between 0.005 to about 0.03 ppm. In some embodiments, the multi-site contact fungicide is applied at a rate between 0.003 to about 0.01 ppm. In some embodiment, the multi-site contact fungicide is applied at a rate of about 0.003 ppm. In some embodiment, the multi-site contact fungicide is applied at a rate of about 0.01 ppm.

In some embodiments, the mancozeb is applied at a rate between 0.005 to about 0.03 ppm. In some embodiments, the mancozeb is applied at a rate between 0.003 to about 0.01 ppm. In some embodiment, the mancozeb is applied at a rate of about 0.003 ppm. In some embodiment, the mancozeb is applied at a rate of about 0.01 ppm.

In some embodiments, the SDHI fungicide is applied at a rate between 0.00005 to about 0.1 ppm. In some embodiments, the SDHI fungicide is applied at a rate between 0.0001 to about 0.07 ppm. In some embodiments, the SDHI fungicide is applied at a rate of about 0.0001 ppm. In some embodiments, the SDHI fungicide is applied at a rate of about 0.0006 ppm. In some embodiments, the SDHI fungicide is applied at a rate of about 0.003 ppm. In some embodiments, the SDHI fungicide is applied at a rate of about 0.01 ppm. In some embodiments, the SDHI fungicide is applied at a rate of about 0.07 ppm.

In some embodiments, the fluxapyroxad is applied at a rate between 0.00005 to about 0.1 ppm. In some embodiments, the fluxapyroxad is applied at a rate between 0.0001 to about 0.07 ppm. In some embodiments, the fluxapyroxad is applied at a rate of about 0.0001 ppm. In some embodiments, the fluxapyroxad is applied at a rate of about 0.0006 ppm. In some embodiments, the fluxapyroxad is applied at a rate of about 0.003 ppm. In some embodiments, the fluxapyroxad is applied at a rate of about 0.01 ppm. In some embodiments, the fluxapyroxad is applied at a rate of about 0.07 ppm.

In some embodiments, the triazole fungicide is applied at a rate between 0.001 to 0.1 ppm. In some embodiments, the triazole fungicide is applied at a rate between 0.01 to 0.03 ppm. In some embodiments, the triazole fungicide is applied at a rate of about 0.02 ppm.

In some embodiments, the prothioconzaole is applied at a rate between 0.001 to 0.1 ppm. In some embodiments, the prothioconzaole is applied at a rate between 0.01 to 0.03 ppm. In some embodiments, the prothioconzaole is applied at a rate of about 0.02 ppm.

In some embodiments, the fenpropidin and the additional fungicide(s) are applied simultaneously.

In some embodiments, the fenpropidin and the additional fungicide(s) are applied contemporaneously.

The fungicidal compositions according to the invention are effective against a broad spectrum of phytopathogenic fungi, especially the ones belonging to the following classes: Ascomycetes (e.g. Venturia, Podosphaera, Ervsiphe, Monilinia, Mvcosphaerella, Uncinula): Basidiomycetes (e.g. the genus Hemileia, Rhizoctonia, Puccinia, Phakopsora); Fungi imperfecti (e.g. Botrytis. Helminthosporium, Rhvnchosporium, Fusarium. Septoria, Cercospora, Alternaria, Pyricularia and Pseudocercosporella herpotrichoides (Tapesia spp.).

In particular, the novel compositions are useful against, brown and yellow rusts, especially Asian soybean rust (Phakopsora pachyrhizi), but also leaf spots, powdery mildew, Cercospora, Ramularia, Hemileia vastatrix.

The combinations, mixtures and compositions according to the invention are effective against a broad spectrum of phytopathogenic fungi, especially the ones belonging to the following classes: Ascomycetes (e.g. Venturia, Podosphaera, Ervsiphe, Monilinia, Mvcosphaerella, Uncinula): Basidiomycetes (e.g. the genus Hemileia, Rhizoctonia, Puccinia, Phakopsora); Fungi imperfecti (e.g. Botrytis. Helminthosporium, Rhvnchosporium, Fusarium. Septoria, Cercospora, Alternaria, Pyricularia and Pseudocercosporella herpotrichoides (Tapesia spp.).

In particular, the novel combinations, mixtures and compositions are useful against, brown and yellow rusts, especially Asian soybean rust (Phakopsora pachyrhizi), but also leaf spots, powdery mildew, Cercospora, Ramularia, Hemileia vastatrix.

In some embodiments, the fungus is Phakopsora pachyrhizi. In some embodiments, the fungal infection is Phakopsora pachyrhizi infection. In some embodiments, the fungal disease is Asian soybean rust. In some embodiments, the fungal disease is Asian soybean rust in soybean. In some embodiments, the mixture is effective for protecting the plant from Asian soybean rust (Phakopsora pachyrhizi). In some embodiments, the mixture is effective for controlling Asian soybean rust (Phakopsora pachyrhizi).

In some embodiments, the fungus is Erysiphe necator. In some embodiments, the fungal infection is Erysiphe necator infection. In some embodiments, the fungal disease is powdery mildew (Erysiphe necator). In some embodiments, the fungal disease is powdery mildew (Erysiphe necator) in grapevines. In some embodiments, the mixture is effective for protecting the plant from powdery mildew (Erysiphe necator). In some embodiments, the mixture is effective for controlling powdery mildew (Erysiphe necator).

In some embodiments, the fungus is Podosphaera leucotricha. In some embodiments, the fungal infection is Podosphaera leucotricha infection. In some embodiments, the fungal disease is powdery mildew (Podosphaera leucotricha). In some embodiments, the fungal disease is powdery mildew (Podosphaera leucotricha) in apple. In some embodiments, the mixture is effective for protecting the plant from powdery mildew (Podosphaera leucotricha). In some embodiments, the mixture is effective for controlling powdery mildew (Podosphaera leucotricha).

In some embodiments, the fungus is Venturia inaequalis. In some embodiments, the fungal infection is Venturia inaequalis infection. In some embodiments, the fungal disease is black spot (Venturia inaequalis). In some embodiments, the fungal disease is black spot (Venturia inaequalis) in apple. In some embodiments, the mixture is effective for protecting the plant from black spot (Venturia inaequalis). In some embodiments, the mixture is effective for controlling black spot (Venturia inaequalis).

In some embodiments, the fungus is Podosphaera xanthii. In some embodiments, the fungal infection is Podosphaera xanthii infection. In some embodiments, the fungal disease is powdery mildew (Podosphaera xanthii). In some embodiments, the fungal disease is powdery mildew (Podosphaera xanthii) in zucchini. In some embodiments, the mixture is effective for protecting the plant from powdery mildew (Podosphaera xanthii). In some embodiments, the mixture is effective for controlling powdery mildew (Podosphaera xanthii).

The composition according to the invention can be used as a fungicide, i.e. for combatting fungal diseases that have already contaminated crop plants but also for the prevention of fungal attacks.

The combination, mixture or composition according to the invention can be used as a fungicide, i.e. for combatting fungal diseases that have already contaminated crop plants but also for the prevention of fungal attacks.

Target crops for the areas of indication disclosed herein comprise the following species of plants: cereals (wheat, barley, rye, oats, rice, sorghum and related crops); beet (sugar beet and fodder beet); pomes, stone fruit and soft fruit (apples, pears, plums, peaches, almonds, cherries, strawberries, raspberries and blackberries); leguminous plants (beans, lentils, peas, soybeans); oil plants (rape, mustard, poppy, olives, sunflowers, coconut, castor oil plants, cocoa beans, groundnuts); cucumber plants (marrows, cucumbers, melons); fibre plants (cotton, flax, hemp, jute); citrus fruit (oranges, lemons, grapefruit, mandarins); vegetables (spinach, lettuce, asparagus, cabbages, carrots, onions, tomatoes, potatoes, paprika); lauraceae (avocados, cinnamon, camphor); or plants such as maize, tobacco, nuts, coffee, sugar cane, tea, vines, hops, bananas and natural rubber plants, as well as ornamentals (flowers, shrubs, broad-leaved trees and evergreens, such as conifers). This list does not represent any limitation.

In some embodiments, the composition of present invention is intended for use on crop of corn, soybean, cotton, canola, cereals or coffee.

In some embodiments, the combination, mixture or composition is for treating crop against fungal infection. Crop includes, but is not limited to, arable crops, vegetables and fruits. In some embodiments, the combination, mixture or composition according to the invention is intended for use on crops of corn, soybean, dry bean, cotton, wheat or coffee. In some embodiments, the combination, mixture or composition according to the invention is intended for use on soybean, dry bean, corn, cotton, cereals, coffee, rice, pome fruit, grapevine, zucchini and/or tomato. In some embodiment, the crop is soybean. In some embodiment, the crop is dry bean. In some embodiment, the crop is corn. In some embodiment, the crop is cotton. In some embodiment, the crop is cereal. In some embodiment, the crop is coffee. In some embodiment, the crop is rice. In some embodiments, the crop is grapevine. In some embodiments, the crop is a pome fruit, preferably apple. In some embodiments, the crop is zucchini. In some embodiment, the crop is tomato.

In some embodiments, the plant is a crop and the method is effective for increasing yield.

The present invention also provides use of any one of the combinations, mixtures or compositions disclosed herein for combatting phytopathogenic diseases on crop plants.

The present invention also provides use of any one of the combinations, mixtures or compositions disclosed herein for treating a plant or soil against fungal infection.

The present invention also provides use of any one of the combinations, mixtures or compositions disclosed herein for protecting a plant or soil from fungal attack.

The present invention also provides use of any one of the combinations, mixtures or compositions disclosed herein for protecting a plant or soil from fungal infection.

The present invention also provides use of any one of the combinations, mixtures or compositions disclosed herein for preventing fungal infection of a plant or soil.

The present invention also provides use of any one of the combinations, mixtures or compositions disclosed herein for controlling fungal infection on a plant or soil.

The present invention also provides use of any one of the combinations, mixtures or compositions disclosed herein for controlling fungal disease infecting a plant.

The present invention also provides a method of treating a plant or soil against Phakopsora pachyrhizi comprising applying an amount of fenpropidin to the plant, propagation material of the plant, or soil so as to thereby treat the plant or soil against Phakopsora pachyrhizi.

In some embodiments, the amount of fenpropidin is effective to treat the plant or soil against Phakopsora pachyrhizi.

The present invention also provides a method of protecting a plant or soil from Phakopsora pachyrhizi attack comprising applying an amount of fenpropidin to the plant, propagation material of the plant, or soil so as to thereby protect the plant or soil against Phakopsora pachyrhizi attack.

In some embodiments, the amount of fenpropidin is effective to protect the plant or soil from Phakopsora pachyrhizi attack.

The present invention also provides a method of controlling Phakopsora pachyrhizi attack on a plant comprising applying an amount of fenpropidin to the plant, propagation material of the plant, or a locus of the plant so as to thereby control the Phakopsora pachyrhizi attack.

In some embodiments, the amount of fenpropidin is effective to control Phakopsora pachyrhizi attack on the plant.

The present invention also provides a method of protecting a plant from Asian soybean rust comprising applying an amount fenpropidin to the plant or a locus thereof so as to thereby protect the plant from Asian soybean rust.

In some embodiments, the amount of fenpropidin is effective to protect the plant from Asian soybean rust.

The present invention also provides a method of controlling Asian soybean rust in a plant comprising applying an amount fenpropidin to the plant or a locus thereof so as to thereby control Asian soybean rust in the plant.

In some embodiments, the amount of fenpropidin is effective to control Asian soybean rust in the plant.

The present invention also provides a method of treating a soybean against infection by Phakopsora pachyrhizi comprising applying an effective amount of fenpropidin to the plant, propagation material of the plant, or soil so as to thereby treat the plant against infection by Phakopsora pachyrhizi.

The present invention also provides a method of treating a soybean against Asian soybean rust comprising applying an effective amount of fenpropidin to the plant, propagation material of the plant, or soil so as to thereby treat the plant against Asian soybean rust.

The present invention also provides use of fenpropidin for combatting phytopathogenic diseases on crop plants.

The present invention also provides use of fenpropidin for protecting a plant from Phakopsora pachyrhizi attack.

The present invention also provides use of fenpropidin for controlling Phakopsora pachyrhizi.

The present invention also provides use of fenpropidin for controlling Phakopsora pachyrhizi infection.

The present invention also provides use of fenpropidin for protecting a plant from Asian soybean rust.

The present invention also provides use of fenpropidin for controlling Asian soybean rust in a plant.

Fenpropidin may be applied at any rate described herein.

In some embodiments, the method and/or use disclosed herein further comprises application of at least one additional fungicide.

In some embodiments, the method and/or use disclosed herein further comprises at least two additional fungicides.

In some embodiments, the additional fungicide(s) is selected from group consisting of a multi-site contact fungicide, a strobilurin fungicide, a succinate dehydrogenase inhibitor (SDHI) fungicide, a triazole fungicide, a dicarboxamide fungicide, a phenylpyrrole (PP) fungicide, a benzophenone fungicide, a phenyl acetamide fungicide, and a pyrimidines fungicide.

In some embodiments, the method is effective for protecting the plant or soil against fungal attack. In some embodiments, the method is effective for preventing fungal infection of the plant or soil. In some embodiments, the method is effective for controlling fungal disease infecting the plant or soil. In some embodiment, the method is effective for reducing fungal infection of the plant or soil.

In some embodiments, the method is effective for increasing plant development compared to the development of a plant to which fenpropidin was not applied. Increasing plant development includes, but is not limited to, enhancing the root systems, enhancing shoot of the crop plant, enhancing plant vigor and/or enhancing plant potential yield.

In some embodiments, plant vigor is assessed using the relative vigor index. In some embodiments, plant vigor is increased by at least 1%, 5%, 10, 20%, 30%, 40%, 50%, 60%, 70%, 80%, or 90%.

In some embodiments, enhancement in root system is measured by root weight. In some embodiments, root weight is increased by at least 1%, 5%, 10, 20%, 30%, 40%, 50%, 60%, 70%, 80%, or 90%.

In some embodiments, enhancement in shoot is measured by shoot weight. In some embodiments, shoot weight is increased by at least 1%, 5%, 10, 20%, 30%, 40%, 50%, 60%, 70%, 80%, or 90%.

In some embodiments, the combinations or mixtures disclosed herein can be formulated as one composition.

In some embodiments, the combinations or mixtures disclosed herein can be formulated in separate compositions.

In some embodiments, the combination or mixture disclosed herein can be formulated in more than one composition.

Number and rates of application depend on the biological and climatic environment of the pathogen. Alternatively, the active ingredients can reach the plant from the soil or water via the root system (systemic action) by drenching the locus of the plant with a liquid preparation (for example in rice growing) or incorporating the substances into the soil in solid form, for example in the form of granules (soil application). The inventive composition can also be applied to seed kernels for the purposes of seed treatment (coating), either by soaking the roots or kernels in succession with a liquid preparation of an active ingredient or by coating them with a moist or dry preparation which already comprises the combination. In addition, other types of application to plants are possible in specific cases, for example the targeted treatment of buds or fruit-bearing parts of the plant.

The inventive combination, mixture or composition can also be applied to seed kernels for the purposes of seed treatment (coating), either by soaking the roots or kernels in succession with a liquid preparation of an active ingredient or by coating them with a moist or dry preparation which already comprises the combination. In addition, other types of application to plants are possible in specific cases, for example the targeted treatment of buds or fruit-bearing parts of the plant.

Target crops for the areas of indication disclosed herein comprise within the scope of this invention e.g. the following species of plants: cereals (wheat, barley, rye, oats, rice, sorghum and related crops); beet (sugar beet and fodder beet); pomes, stone fruit and soft fruit (apples, pears, plums, peaches, almonds, cherries, strawberries, raspberries and black-berries); leguminous plants (beans, lentils, peas, soybeans); oil plants (rape, mustard, poppy, olives, sunflowers, coconut, castor oil plants, cocoa beans, groundnuts); cucumber plants (marrows, cucumbers, melons); fibre plants (cotton, flax, hemp, jute); citrus fruit (oranges, lemons, grapefruit, mandarins); vegetables (spinach, lettuce, asparagus, cabbages, carrots, onions, tomatoes, potatoes, cucurbits, paprika); lauraceae (avocados, cinnamon, camphor); or plants such as maize, tobacco, nuts, coffee, sugar cane, tea, vines, hops, bananas and natural rubber plants, as well as ornamentals (flowers, shrubs, broad-leaved trees and evergreens, such as conifers). This list does not represent any limitation.

The composition of the invention may be formulated into any conventional type of formulation. The composition of the invention may be employed in any conventional form, especially in the form of water dispersible granules, coated granules, emulsifiable concentrate, suspension concentrate, microemulsion, oil dispersion, suspo-emulsion, capsule suspension, a mixed formulation of capsule suspension and suspension concentrate.

Such compositions may be produced in conventional manner, e.g. by mixing the active ingredients with appropriate adjuvants (diluents or solvents and optionally other formulating ingredients such as surfactants).

Suitable carriers and adjuvants may be solid or liquid and correspond to the substances ordinarily employed in formulation technology, such as, e.g. natural or regenerated mineral substances, solvents, dispersants, wetting fungicides, tackifiers, thickeners, binding fungicides or fertilisers. Such carriers are for example described in WO 96/22690.

Particularly formulations to be applied in spraying forms such as water dispersible concentrates or wettable powders may contain surfactants such as wetting and dispersing fungicides, e.g. the condensation product of formaldehyde with naphthalene sulphonate, an alkylarylsulphonate, a lignin sulphonate, a fatty alkyl sulphate, and ethoxylated alkylphenol and an ethoxylated fatty alcohol.

The composition according to the invention is generally formulated in various ways using formulation adjuvants, such as carriers, solvents and surface-active substances. The formulations can be in various physical forms, e.g. in the form of dusting powders, gels, wettable powders, water-dispersible granules, water-dispersible tablets, effervescent pellets, emulsifiable concentrates, microemulsifiable concentrates, oil-in-water emulsions, oil-flowables, aqueous dispersions, oily dispersions, suspo-emulsions, capsule suspensions, emulsifiable granules, soluble liquids, water-soluble concentrates (with water or a water-miscible organic solvent as carrier), impregnated polymer films or in other forms known e.g. from the Manual on Development and Use of FAO and WHO Specifications for Pesticides, United Nations, First Edition, Second Revision (2010). Such formulations can either be used directly or diluted prior to use. The dilutions can be made, for example, with water, liquid fertilisers, micronutrients, biological organisms, oil or solvents. The formulations can be prepared e.g. by mixing the active ingredient with the formulation adjuvants in order to obtain compositions in the form of finely divided solids, granules, solutions, dispersions or emulsions. The active ingredients can also be formulated with other adjuvants, such as finely divided solids, mineral oils, oils of vegetable or animal origin, modified oils of vegetable or animal origin, organic solvents, water, surface-active substances or combinations thereof.

The active ingredients can also be contained in microcapsules. Microcapsules contain the active ingredients in a porous carrier. This enables the active ingredients to be released into the environment in controlled amounts (e.g. slow-release). Microcapsules usually have a diameter of from 0.1 to 500 microns. They contain active ingredients in an amount of from about 25 to 95% by weight of the capsule weight. The active ingredients can be in the form of a monolithic solid, in the form of fine particles in solid or liquid dispersion or in the form of a suitable solution. The encapsulating membranes can comprise, for example, natural or synthetic rubbers, cellulose, styrene/butadiene copolymers, polyacrylonitrile, polyacrylate, polyesters, polyamides, polyureas, polyurethane or chemically modified polymers and starch xanthates or other polymers that are known to the person skilled in the art. Alternatively, very fine microcapsules can be formed in which the active ingredient is contained in the form of finely divided particles in a solid matrix of base substance, but the microcapsules are not themselves encapsulated.

The formulation adjuvants that are suitable for the preparation of the formulations according to the invention are known per se. As liquid carriers there may be used: water, toluene, xylene, petroleum ether, vegetable oils, acetone, methyl ethyl ketone, cyclohexanone, acid anhydrides, acetonitrile, acetophenone, amyl acetate, 2-butanone, butylene carbonate, chlorobenzene, cyclohexane, cyclohexanol, alkyl esters of acetic acid, diacetone alcohol, 1,2-dichloropropane, diethanolamine, p-diethylbenzene, diethylene glycol, diethylene glycol abietate, diethylene glycol butyl ether, diethylene glycol ethyl ether, diethylene glycol methyl ether, /V,/V-dimethylformamide, dimethyl sulfoxide, 1,4-dioxane, dipropylene glycol, dipropylene glycol methyl ether, dipropylene glycol dibenzoate, diproxitol, alkylpyrrolidone, ethyl acetate, 2-ethylhexanol, ethylene carbonate, 1,1,1-trichloroethane, 2-heptanone, alpha-pinene, d-limonene, ethyl lactate, ethylene glycol, ethylene glycol butyl ether, ethylene glycol methyl ether, gamma-butyrolactone, glycerol, glycerol acetate, glycerol diacetate, glycerol triacetate, hexadecane, hexylene glycol, isoamyl acetate, isobornyl acetate, isooctane, isophorone, isopropylbenzene, isopropyl myristate, lactic acid, laurylamine, mesityl oxide, methoxypropanol, methyl isoamyl ketone, methyl isobutyl ketone, methyl laurate, methyl octanoate, methyl oleate, methylene chloride, m-xylene, n-hexane, n-octylamine, octadecanoic acid, octylamine acetate, oleic acid, oleylamine, o-xylene, phenol, polyethylene glycol, propionic acid, propyl lactate, propylene carbonate, propylene glycol, propylene glycol methyl ether, p-xylene, toluene, triethyl phosphate, triethylene glycol, xylenesulfonic acid, paraffin, mineral oil, trichloroethylene, perchloroethylene, ethyl acetate, amyl acetate, butyl acetate, propylene glycol methyl ether, diethylene glycol methyl ether, methanol, ethanol, isopropanol, and alcohols of higher molecular weight, such as amyl alcohol, tetrahydrofurfuryl alcohol, hexanol, octanol, ethylene glycol, propylene glycol, glycerol, V-methyl-2-pyrrolidone and the like.

Suitable solid carriers are, for example, talc, titanium dioxide, pyrophyllite clay, silica, attapulgite clay, kieselguhr, limestone, calcium carbonate, bentonite, calcium montmorillonite, cottonseed husks, wheat flour, soybean flour, pumice, wood flour, ground walnut shells, lignin and similar substances.

A large number of surface-active substances can advantageously be used in both solid and liquid formulations, especially in those formulations which can be diluted with a carrier prior to use. Surface-active substances may be anionic, cationic, non-ionic or polymeric and they can be used as emulsifiers, wetting fungicides or suspending fungicides or for other purposes. Typical surface-active substances include, for example, salts of alkyl sulfates, such as diethanolammonium lauryl sulfate; salts of alkylarylsulfonates, such as calcium dodecylbenzenesulfonate; alkylphenol/alkylene oxide addition products, such as nonylphenol ethoxylate; alcohol/alkylene oxide addition products, such as tridecylalcohol ethoxylate; soaps, such as sodium stearate; salts of alkylnaphthalenesulfonates, such as sodium dibutylnaphthalenesulfonate; dialkyl esters of sulfosuccinate salts, such as sodium di(2-ethylhexyl)sulfosuccinate; sorbitol esters, such as sorbitol oleate; quaternary amines, such as lauryltrimethylammonium chloride, polyethylene glycol esters of fatty acids, such as polyethylene glycol stearate; block copolymers of ethylene oxide and propylene oxide; and salts of mono- and di-alkylphosphate esters.

Further adjuvants that can be used in pesticidal formulations include crystallisation inhibitors, viscosity modifiers, suspending fungicides, dyes, anti-oxidants, foaming fungicides, light absorbers, mixing auxiliaries, antifoams, complexing fungicides, neutralising or pH-modifying substances and buffers, corrosion inhibitors, fragrances, wetting fungicides, take-up enhancers, micronutrients, plasticisers, glidants, lubricants, dispersants, thickeners, antifreezes, microbicides, and liquid and solid fertilisers.

The formulations according to the invention can include an additive comprising an oil of vegetable or animal origin, a mineral oil, alkyl esters of such oils or mixtures of such oils and oil derivatives. The amount of oil additive in the formulation according to the invention is generally from 0.01 to 10%, based on the mixture to be applied. For example, the oil additive can be added to a spray tank in the desired concentration after a spray mixture has been prepared. Preferred oil additives comprise mineral oils or an oil of vegetable origin, for example rapeseed oil, olive oil or sunflower oil, emulsified vegetable oil, alkyl esters of oils of vegetable origin, for example the methyl derivatives, or an oil of animal origin, such as fish oil or beef tallow. Preferred oil additives comprise alkyl esters of C8-C22 fatty acids, especially the methyl derivatives of C12-C18 fatty acids, for example the methyl esters of lauric acid, palmitic acid and oleic acid (methyl laurate, methyl palmitate and methyl oleate, respectively).

A seed dressing formulation is applied in a manner known per se to the seeds employing the combination of the invention and a diluent in suitable seed dressing formulation form, e.g. as an aqueous suspension or in a dry powder form having good adherence to the seeds. Such seed dressing formulations are known in the art. Seed dressing formulations may contain the single active ingredients or the combination of active ingredients in encapsulated form, e.g. as slow release capsules or microcapsules. In general, the formulations include from 0.01 to 90% by weight of active fungicide, from 0 to 20% agriculturally acceptable surfactant and 10 to 99.99% solid or liquid adjuvant(s), the active fungicide consisting of at least the compound of formula I together with a compound of component b), and optionally other active fungicides, particularly guazatin and fenpiclonil. Concentrate forms of compositions generally contain in between about 2 and 80%, preferably between about 5 and 70% by weight of active fungicide. Application forms of formulation may for example contain from 0.01 to 20% by weight, preferably from 0.01 to 5% by weight of active fungicide.

The present invention also provides a package comprising any one of the combinations, mixtures or compositions disclosed herein.

In some embodiments, the combination, composition or mixture of the present invention further comprises at least one additional pesticide. In some embodiments, the method or use of the present invention further comprises application of at least one additional pesticide. In some embodiments, the pesticide is herbicide, insecticide, acaricides, or nematicide.

In some embodiments, the package comprises instructions for using the combination, mixture or composition for protecting a plant from fungal attack. In some embodiments, the package comprises instructions for using the combination, mixture or composition for controlling fungal disease infecting a plant. In some embodiments, the instructions comprise application rates, application times, target fungal pathogen, and/or target plant as described herein.

The present invention also provides a process of preparing a combination, mixture or composition comprising (a) an amount of fenpropidin, and an amount of at least one additional fungicide selected from the group consisting of:
(b) a multi-site contact fungicide,
(c) a strobilurin fungicide,
(d) a succinate dehydrogenase inhibitor (SDHI) fungicide,
(e) a triazole fungicide,
(f) a dicarboxamide fungicide,
(g) a phenylpyrrole (PP) fungicide,
(h) a benzophenone fungicide,
(i) a phenyl acetamide fungicide, and
(j) a pyrimidines fungicide,
   wherein the process comprises the steps of:
   (i) obtaining the amount of fenpropidin and the amount of the additional fungicide(s), and
   (ii) mixing the obtained amount of fenpropidin and the additional fungicide to obtain the combination, mixture or composition.
   In some embodiments, the amount of fenpropidin in the combination, mixture or composition is less than the fungicidally effective amount of fenpropidin when fenpropidin is used alone.
   In some embodiments, the amount of the additional fungicide(s) in the combination, mixture or composition is less than the fungicidally effective amount of the additional fungicide(s) when the additional fungicide(s) is used alone.

In some embodiments, step (iii) is performed in a tank to obtain a tank mix.

In some embodiments, the process further comprises adding an agrochemically acceptable carrier to the combination, mixture or composition.

Each embodiment disclosed herein is contemplated as being applicable to each of the other disclosed embodiments. Thus, all combinations of the various elements described herein are within the scope of the invention. In addition, the elements recited in the composition embodiments can be used in the combination, mixture (including synergistic mixture), package, method and use embodiments described herein and vice versa.

The present invention is illustrated and further described in more detail with reference to the following non-limiting examples. The following examples illustrate the practice of the present subject matter in some of its embodiments but should not be construed as limiting the scope of the present subject matter. Other embodiments will be apparent to one skilled in the art from consideration of the specification and examples. It is intended that the specification, including the examples, is considered exemplary only without limiting the scope and spirit of the present subject matter.

### FORMULATION EXAMPLES

### Example 1—Water Dispersible Granules

The composition contains the following ingredients:
Active ingredient: fenpropidin:picoxystrobin (weight ratio of 1:3) 15 wt %
Sodium lignosulfonate 5 wt %
Sodium laurylsulfate 3 wt %
Sodium diisobutylnaphthalene-sulfonate 6 wt %
Octylphenol polyethylene glycol ether (?−8 mol of ethylene oxide) 2 wt %
Highly disperse silica 10 wt %
Kaolin 59 wt %.

The active ingredient is mixed thoroughly with the additives and the mixture is ground thoroughly in a suitable mill. The resultant powder is then converted to a granule by agglomeration using a pan-granulator or similar device using water or water containing an adhesive. Alternatively, the water-dispersible granules can be prepared by a method comprising mixing the desired ingredients of the granules into an extrudable form, extruding the mix and then rolling the extrusions and optionally drying if desired. This gives granular formulations which can be dispersed readily in water and remain in suspension, i.e. perform as well as liquid flowables and wettable powders when prepared for spray application to soil or plants.

### Example 2—Emulsion Concentrate

The composition contains the following ingredients:
Active ingredient: fenpropidin:fluxapyroxad and mancozeb (1:5) 10 wt %
Octylphenol polyethylene glycol ether (4-5 mol of ethylene oxide) 3 wt %
Calcium dodecylbenzenesulfonate 3 wt %
Castor oil polyglycol ether (35 mol of ethylene oxide) 4 wt %
Cyclohexanone 30 wt %
Xylene 50 wt %.

Emulsions of any desired dilution which can be employed in crop protection can be prepared from this concentrate by dilution with water.

### Example 3—Coated Granules

The composition contains the following ingredients:
Active ingredient: fenpropidin:fluxapyroxad and chlorthalonil (1:3) 8 wt %
Polyethylene glycol (MW 200) 3 wt %
Kaolin 89 wt %
   (MW stands for molecular weight).

In a mixer, the finely ground active ingredient is applied uniformly to the kaolin which has been moistened with polyethylene glycol. This gives dust-free coated granules.

### Example 4—Suspension Concentrate

The composition contains the following ingredients:
Active ingredient: fenpropidin:mancozeb (1:2) 40 wt %
Propylene glycol 10 wt %
Nonylphenol polyethylene glycol ether (15 mol of ethylene oxide) 6 wt %
Sodium lignosulfonate 10 wt %
Carboxymethylcellulose 1 wt %
Silicone oil (in the form of a 75% aqueous emulsion) 1 wt %
Water 32 wt %.

The finely ground active ingredient is mixed intimately with the additives. This gives a suspension concentrate from which suspensions of any desired dilution can be prepared by dilution with water. Such dilutions can be used for treating live plants and plant propagation material by means of spraying, pouring-on or immersion and for protecting them against microbial infection.

### Biological Examples

In the field of agriculture, it is often understood that the term “synergy” is as defined by (1) Colby S. R. in an article entitled “Calculation of the synergistic and antagonistic responses of herbicide combinations” published in the journal Weeds, 1967, 15, p. 20-22, and (2) Wadley (Ulrich Gisi, Phytopathology, 86, 1996, 1273-1279)

Under the Colby approach, a synergistic effect is present if the action of the combination of active ingredients exceeds the total of the actions of the individual components. The expected action E for a given combination of active ingredients can be described by the so-called COLBY formula and can be calculated as follows (COLBY, S. R. “Calculating synergistic and antagonistic responses of herbicide combination”. Weeds, Vol. 15, pages 20-22; 1967).

ppm=milligrams of active ingredient (=a.i.) per litre of spray mixture
X=% action caused by active ingredient I at a rate of application of p ppm of active ingredient
Y=% action caused by active ingredient II at a rate of q ppm of active ingredient
E=expected action of active ingredients I+II at a rate of application of p+q ppm of active ingredient (additive action),
X−Y then Colby's formula reads E=X+Y−100

If the actually observed action (O) exceeds the expected action (E), the action of the combination is superadditive, i.e. there is a synergistic effect. O E=factory of synergism (FS).

The action expected for a given combination of two active components can be calculated as follows:

$$E = X + Y - \frac{XY}{100}$$

The action expected for a given combination of three active components can be calculated as follows:

$$E = X + Y + Z - \frac{XY + XZ + YZ}{100} + \frac{XYZ}{10000}$$

in which E represents the expected effect, e.g. percentage of pest control, for the combination of the three active ingredient at defined doses (for example equal to x, y and z respectively), X is the effect, e.g. percentage of pest control, observed for compound (I) at a defined dose (equal to x), Y is the effect, e.g. percentage of pest control, observed for compound (II) at a defined dose (equal to y), Z is the effect, e.g. percentage of pest control, observed for compound (III) at a defined dose (equal to z). When the effect, e.g. percentage of pest control, observed for the combination is greater than the expected effect, there is a synergistic effect. The ratio of observed action (E_{obs}) and expected action (Eₑₓₚ), i.e. E_{obs}/Eₑₓₚ expresses the factor of interaction level (R) which may be interpreted in accordance with Table 1a below.

TABLE 1a
Colby interaction level

| | |
|---|---|
| R > 1 | Synergy |
| R = 1 | Additivity |
| R < 1 | Antagonism |

A synergistic effect may also be shown by using the Wadley method. The Wadley formula predicts the expected effective concentration (EC_{theoretical}) at different control levels (50% or 90%).

In the Wadley method, synergistic activity is determined from dose response curves. With this method, the efficacy of the active ingredient (“a.i.”) is determined by comparing the degree of fungal attack on treated plants with that on untreated, similarly inoculated and incubated check plants. Each a.i. is generally tested at multiple. (e.g., 6) concentrations, and dose response curves are generated. The dose response curves are used to establish the EC50 (i.e., the effective concentration of a.i. providing 50% disease control) of the individual compounds as well as of the combinations (EC50Observed). The experimentally found values of the mixture at a given weight ratio are compared with the values that would have been found were only a complementary efficacy of the components was present as follows:

ECₜₕₑₒ=(a+b)/[(a/EC_{A})+(b/EC_{B})]

A and B=the single products tested

a and b=the ratio of each product in the mixture

EC_{A} and EC_{B}=observed effective concentration of the single products A and B at different control levels (50 or 90%)

R=ECₜₕₑₒ/EC_{observed}

For three-way mixture:

ECₜₕₑₒ=(a+b+c)/[(a/EC_{A})+(b/EC_{B}+(c/EC_{C})]

a, b and c=the ratio of each product in the mixture

EC_{A}, EC_{B} and EC_{C}=observed effective concentration of the single products A B and C at different control levels (50 or 90%).

The ratio EC50 (A+B)_{Theo}/EC50(A+B)_{observed} expresses the factor of interaction level (R) which may be interpreted in accordance with Table 1b below.

TABLE 1b
Wadley interaction level

| | |
|---|---|
| R > 1.5 | Synergy |
| 0.5 < R < 1.5 | Additivity |
| R < 0.5 | Antagonism |

The Colby approach allows determination of the type of fungicide mixtures interaction at one dose. It is adapted for field and laboratory studies and gives the a.i. interaction at the evaluated dose. The Colby approach is dose dependent.

The Wadley approach evaluates the type of fungicide mixtures interaction within a range of concentrations. It is more adapted for laboratory studies and permits to evaluate the intrinsic a.i. interaction. The Wadley approach is dose independent.

### Example 5—Synergistic Effect of the Combination of Fenpropidin and Mancozeb, and the Combination of Fenpropidin, Mancozeb and Fluxapyroxad

Soybean rust, caused by Phakopsora pachyrhizi, is one of the most important foliar diseases of soybean worldwide. Seed of soybean were sown in pots in a loam-vermiculite soil mix and placed inside a growth chamber maintained at 18° C./26° C. night/day and 60 to 70% RH with 16 h of light for 3 weeks.

First leaves were harvested and placed in Petri dishes on 1% water agar. A spore suspension (1×105 spores/ml of water) were prepared from infected leaf samples and was sprayed on leaf pieces using an atomizer attached to an air compressor. Petri dishes containing leaf pieces were incubated inside a growth chamber maintained at 18° C./26° C. night/day and 60 to 70% RH with 16 h of light during 2-3 weeks. Urediniospores (1×105 spores/ml of water) were harvested from infected leaf samples and equal volumes of spore suspension and fungicide diluted in water were mixed in 96 well plate. Spores are stained by two fluorescent dyes, one which stained dead spores and a one for which intensity of staining is directly correlated to metabolic activity.

Flow cytometric analyses were performed on a CyFlow Cube 8 equipped with an autoloading station (Sysmex Partec GmbH, Gorlittz, Germany). The fluorescences were collected for 2000 to 3000 spores per well and were used to discriminate: (i) healthy spores and (ii) dead spores. The fungicide efficacies were then calculated from the percentage of healthy spores in control condition and in treated condition.

Data and calculations using the Wadley approach are shown in Tables 2-8. The EC50 is based the perturbation of the metabolic activity.

TABLE 2

| | Technical Fenpropidin | | | | | | | | |
|---|---|---|---|---|---|---|---|---|---|
| Dose (ppm) | 0 | 0.0004608 | 0.002304 | 0.01152 | 0.0576 | 0.288 | 1.44 | 7.2 | EC₅₀ |

| | | | | | | | | |
|---|---|---|---|---|---|---|---|---|
| % of efficiency | 24.5 | 7.6 | 23.4 | 10.9 | 15.4 | 13.2 | 8.4 | >7.2 ppm |
| Exp 1 | | | | | | | | (88.916 ppm in 2018) |
| % of efficiency | 14.8 | 16.8 | 5.8 | 12.4 | 9.9 | 7.6 | 18.7 | >7.2 ppm |
| Exp 2 | | | | | | | | (88.916 ppm in 2018) |
| % of efficiency | 7.6 | 6.1 | 26.4 | 15.5 | 14.6 | 28.5 | 23.1 | >7.2 ppm |
| Exp 3 | | | | | | | | (88.916 ppm in 2018) |
| Mean | 15.65 | 10.17 | 18.55 | 12.90 | 13.31 | 16.42 | 16.74 | >7.2 ppm |
| | | | | | | | | (88.916 ppm in 2018) |
| s-d | 8.48 | 8.83 | 11.10 | 2.36 | 2.96 | 10.83 | 7.52 | n.d. |

TABLE 3

| | Formulated Mancozeb | | | | | | | | |
|---|---|---|---|---|---|---|---|---|---|
| Dose (ppm) | 0 | 0.00256 | 0.0128 | 0.064 | 0.32 | 1.6 | 8 | 40 | EC₅₀ |

| | | | | | | | | |
|---|---|---|---|---|---|---|---|---|
| % of efficiency | 4.2 | 39.9 | 59.2 | 80.8 | 93.6 | 89.4 | 92.3 | <>0.037 ppm |
| Exp 3 | | | | | | | | |
| % of efficiency | 1.8 | 26.2 | 43.2 | 94.2 | 98.7 | 98.9 | 99.5 | <>0.058 ppm |
| Exp 2 | | | | | | | | |
| % of efficiency | 27.6 | 33.7 | 49.7 | 89.3 | 93.2 | 96.6 | 97.8 | <>0.032 ppm |
| Exp 3 | | | | | | | | |
| Mean | 11.22 | 33.27 | 50.88 | 88.10 | 95.20 | 94.99 | 96.58 | <>0.042 ppm |
| s-d | 14.27 | 6.88 | 8.04 | 6.80 | 3.07 | 4.96 | 3.79 | 0.0138 |

TABLE 4

| | Technical Fluxapyroxad | | | | | | | | |
|---|---|---|---|---|---|---|---|---|---|
| Dose (ppm) | 0 | 0.0001152 | 0.000576 | 0.00288 | 0.0144 | 0.072 | 0.36 | 1.8 | EC₅₀ |

| | | | | | | | | |
|---|---|---|---|---|---|---|---|---|
| % of efficiency | 23.8 | 19.6 | 18.6 | 26.1 | 28.8 | 61.7 | 88.5 | <>0.190 ppm |
| Exp 1 | | | | | | | | |
| % of efficiency | 22.9 | 16.8 | 18.6 | 17.6 | 28.6 | 52.3 | 83.4 | <>0.214 ppm |
| Exp 2 | | | | | | | | |
| % of efficiency | 11.1 | 9.4 | 37.0 | 11.5 | 29.9 | 65.2 | 70.6 | <>0.202 ppm |
| Exp 3 | | | | | | | | |
| Mean | 19.26 | 15.24 | 24.72 | 18.40 | 29.12 | 59.74 | 80.82 | <>0.202 ppm |
| s-d | 7.12 | 5.29 | 10.61 | 7.30 | 0.71 | 6.69 | 9.17 | 0.0120 |

TABLE 5

| | Fenpropidin:Mancozeb (0.18:1) | | | | | | | | |
|---|---|---|---|---|---|---|---|---|---|
| Dose (ppm) | 0 | 0.0030208 | 0.015104 | 0.07552 | 0.3776 | 1.888 | 9.44 | 47.2 | EC₅₀ |

| | | | | | | | | |
|---|---|---|---|---|---|---|---|---|
| % of efficiency | 37.7 | 72.9 | 71.9 | 81.4 | 92.8 | 91.6 | 94.2 | <>0.005 ppm |
| Exp 1 | | | | | | | | |
| % of efficiency | 38.7 | 52.2 | 65.0 | 96.7 | 98.6 | 98.7 | 99.2 | <>0.011 ppm |
| Exp 2 | | | | | | | | |
| % of efficiency | 42.8 | 63.3 | 75.5 | 71.2 | 81.1 | 91.5 | 92.1 | <>0.004 ppm |
| Exp 3 | | | | | | | | |
| Mean | 38.75 | 62.83 | 79.79 | 83.11 | 90.83 | 93.93 | 95.47 | <>0.007 ppm |
| s-d | 2.71 | 10.34 | 5.34 | 12.83 | 8.88 | 4.14 | 3.64 | 0.004 |

TABLE 6

| | Fenpropidin:Fluxapyroxad (4:1) | | | | | | | | |
|---|---|---|---|---|---|---|---|---|---|
| Dose (ppm) | 0 | 0.000576 | 0.00288 | 0.0144 | 0.072 | 036 | 1.8 | 9 | EC₅₀ |

| | | | | | | | | |
|---|---|---|---|---|---|---|---|---|
| % of efficiency | 45.0 | 45.7 | 39.7 | 42.0 | 48.4 | 70.7 | 92.9 | <>0.5 ppm |
| Exp 1 | | | | | | | | |
| % of efficiency | 54.9 | 57.1 | 51.1 | 50.8 | 56.2 | 70.6 | 92.8 | <0.000576 ppm |
| Exp 2 | | | | | | | | |
| % of efficiency | 34.5 | 48.4 | 46.4 | 39.8 | 43.7 | 61.5 | 71.3 | <>0.5 ppm |
| Exp 3 | | | | | | | | |
| Mean | 44.83 | 50.39 | 48.82 | 48.27 | 52.29 | 67.57 | 85.65 | <>0.334 ppm |
| s-d | 10.19 | 5.96 | 4.11 | 3.79 | 3.93 | 5.28 | 12.46 | 0.288 |

TABLE 7

| | Fenpropidin:Mancozeb:Fluxapyroxad (4:22.5:1) | | | | | | | | |
|---|---|---|---|---|---|---|---|---|---|
| Dose (ppm) | 0 | 0.093136 | 0.01568 | 0.0784 | 0.392 | 1.96 | 9.8 | 49 | EC₅₀ |

| | | | | | | | | |
|---|---|---|---|---|---|---|---|---|
| % of efficiency | 66.6 | 70.3 | 68.5 | 96.1 | 98.9 | 98.5 | 99.3 | <0.003136 ppm |
| Exp 1 | | | | | | | | |
| % of efficiency | 76.4 | 85.4 | 90.8 | 92.2 | 92.9 | 95.9 | 96.1 | <0.003136 ppm |
| Exp 2 | | | | | | | | |
| % of efficiency | 54.2 | 62.8 | 65.2 | 68.7 | 79.2 | 83.3 | 84.0 | <0.003136 ppm |
| Exp 3 | | | | | | | | |
| Mean | 65.73 | 72.85 | 74.85 | 85.84 | 90.35 | 92.55 | 93.12 | <0.003136 ppm |
| s-d | 11.11 | 11.48 | 13.93 | 14.82 | 10.08 | 8.10 | 8.09 | n.d. |

TABLE 8

| Mixture | Ratio | EC_{50 Theo} | *EC_{50 Observed} | R value | Interaction |
|---|---|---|---|---|---|
| Fenpropidin:Mancozeb | 0.18:1 | 0.05 | 0.007 | 7.66 | Synergy |
| Fenpropidin:Fluxapyroxad | 4:1 | 1.00 | 0.334 | 3 | Synergy |
| Fenpropidin:Mancozeb:Fluxapyroxad | 4:22.5:1 | 0.05 | 0.003136 | 16.35 | Synergy |

*Mean of EC₅₀

Data and calculations using the Colby method for different dosage of active fungicides are presented in Tables 9-11 below.

TABLE 9

| | Dose | | Dose | |
|---|---|---|---|---|
| Active ingredient | (ppm) | Efficacy % | (ppm) | Efficacy % |
| Fenpropidin | 0.01152 | 18.55 | 0.002304 | 10.17 |
| Fluxapyroxad | 0.00288 | 24.72 | 0.000576 | 15.24 |
| Mancozeb | 0.064 | 50.68 | 0.0128 | 33.27 |
| Desthio- | 0.004544 | 38.49 | 0.02272 | 49.44 |
| prothiconazole | | | | |

TABLE 10

| Mixture | Dose | % C_{Theo} | *% C_{Observed} | R value | Interaction |
|---|---|---|---|---|---|
| Fenpropidin:Mancozeb | 0.002304:0.0128 | 40.06 | 62.83 | 1.57 | Synergy |
| Fenpropidin:Fluxapyroxad | 0.002304:0.000576 | 23.86 | 50.39 | 2.11 | Synergy |
| Fenpropidin:Mancozeb:Fluxapyroxad | 0.002304:0.0128:0.000576 | 48.16 | 72.85 | 1.51 | Synergy |
| Fenpropidin:Mancozeb | 0.01152:0.064 | 59.83 | 70.79 | 1.17 | Synergy |
| Fenpropidin:Fluxapyroxad | 0.01152:0.00288 | 38.69 | 46.82 | 1.21 | Synergy |
| Mancozeb:Fluxapyroxad | 0.064:0.00288 | 62.87 | 85.09 | 1.35 | Synergy |
| Fenpropidin:Mancozeb:Fluxapyroxad | 0.01152:0.064:0.00288 | 69.76 | 74.85 | 1.07 | Synergy |

TABLE 11

| Mixture | Dose | % C_{Theo} | *% C_{Observed} | R value | Interaction |
|---|---|---|---|---|---|
| Fenpropidin:desthio- | 0.01152:0.004544 | 49.9 | 55.01 | 1.1 | Synergy |
| prothioconazole | | | | | |

*Desthio-prothioconazole is an equivalent (active structure) to the pro-fungicide prothioconazole.

Results showed a strong synergistic effect between fenpropidin and mancozeb. Results also showed a strong synergistic effect between fenpropidin and fluxapyroxad. Results also shows a strong synergistic effect between fenpropidin, mancozeb and fluxapyroxad. Results also shows a strong synergistic effect between fenpropidin and desthio-prothioconazole.

### Example 6—Fenpropidin as Control Fungicide for Phakopsora pachyrhizi

The experiments for fungicide tests for Asian soybean rust (Phakopsora pachyrhizi) were carried out at Experimental Stations in different regions of Brazil. Each plot consisted of at least 15.0 m² (3.0 m×5.0 m). The experimental design was a randomized block design with four replicates, using soybean varieties adapted to each region. Three applications of foliar treatments were carried out at 10 to 15 day intervals, depending on the soybean rust pressure at each site. The applications were made with backpack sprayer pressurized with CO² set to apply 150 L. ha-1 of spray volume and 0.460 L/min per nozzle. It was used a bar with 3.0 m equipped with 6 nozzles spaced 0.5 m apart, conducted at a height of 0.5 m above plants canopy. The nozzles used was Teejet® XR 110 02 flat jet. The working pressure of de sprayer was 15 PSI (1 Bar) with the experiments were carried out in the 2018/2019 harvest. The applications of the treatments were performed when the soybean was in stages 60 (First flowers opened (sporadically in population), 72 (About 20% of pods have reached final length (15-20 mm)) and 79 (Approx. pods have reached final length (15-20 mm), seeds filling the cavity of the majority of pods) of the BBCH international scale, respectively. The results were evaluated prior to the application of the treatments, and at 7, 14 and 21, 28 and 35 days after the first application through the visual evaluation of the percentage of disease severity per plot. The harvest was evaluated at a minimum of 5.0 m² per plot, and the data were transformed into kg·ha-1.

The active ingredients and their application rates are shown in Table 12 below.

TABLE 12

| | | | | | Rate |
|---|---|---|---|---|---|
| N. | Product | Form. | A.I. | g. a.i./ha | (mL or g/ha) |
| 1 | Untreated | — | — | — | — |
| 2 | ADAFF0103/17* | 750 EC | Fenpropidin | 75 | 100 |
| 3 | ADAFF0103/17* | 750 EC | Fenpropidin | 100 | 134 |
| 4 | ADAFF0103/17* | 750 EC | Fenpropidin | 150 | 200 |
| 5 | ADAFF0103/17* | 750 EC | Fenpropidin | 200 | 267 |
| 6 | ADAFF0103/17* | 750 EC | Fenpropidin | 250 | 334 |
| 7 | ADAFF0103/17* | 750 EC | Fenpropidin | 300 | 400 |
| 8 | INERT/Blank (Fenpropidin)* | 25% | Inerte | — | 267 |
| 9 | Unix 750 WG* | 750 WG | Cyprodinil | 375 | 500 |
| 10 | Unix 750 WG* | 750 WG | Cyprodinil | 562.5 | 750 |
| 11 | Unix 750 WG* | 750 WG | Cyprodinil | 750 | 1000 |
| 12 | Pulsor 240 SC* | 240 SC | Thifluzamide | 120 | 500 |
| 13 | Pulsor 240 SC* | 240 SC | Thifluzamide | 180 | 750 |
| 14 | Pulsor 240 SC* | 240 SC | Thifluzamide | 240 | 1000 |

*Add 0.5% v/v of Rumba
** Add 0.25% v/v of Rumba
Spray volume - 150 L/ha

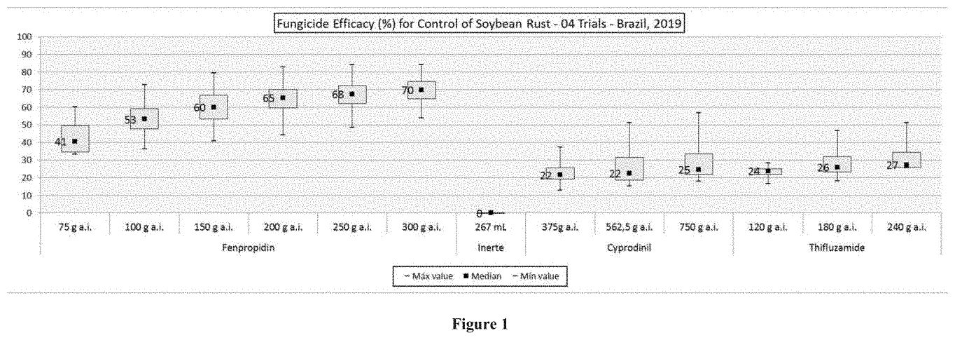

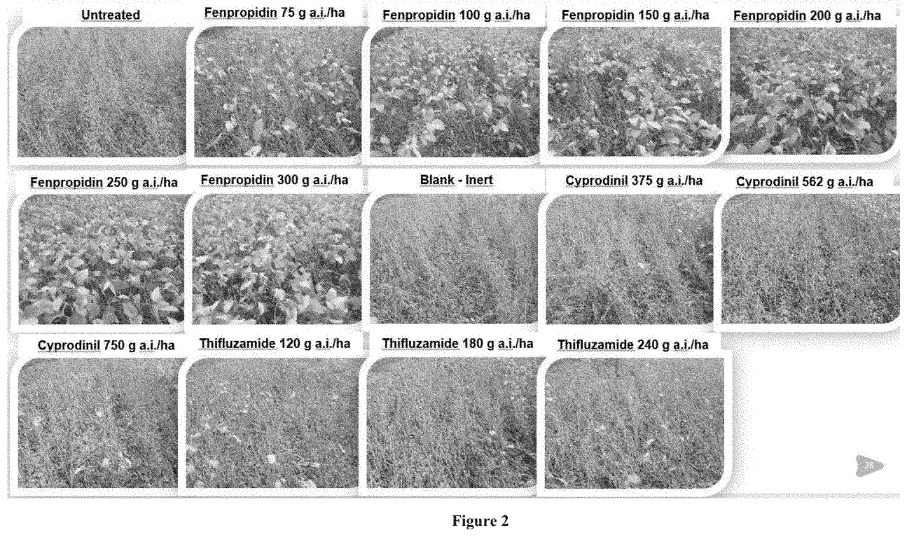

The results are shown in FIGS. 1 and 2.

Out of the three fungicides tested against Phakopsora pachyrhizi, only fenpropidin was effective against Phakopsora pachyrhizi.

### Example 7—Efficacy Assessment of Combinations of Fenpropidin and One Additional Fungicide

Combinations of fenpropidin and one additional fungicide were evaluated for their efficacy in controlling soybean rust and improving crop yield.

The combinations tested and their application rates are summarized in Table 13 below.

TABLE 13

| | | | | | Rate |
|---|---|---|---|---|---|
| N. | Product | Formulation | A.I. | g a.i./ha | (mL or g/ha) |
| 1 | Untreated | — | — | — | — |
| 2 | Pulsor 240 SC | 240 SC | Thifluzamide | 120 | 500 |
| | ADAFF0103/17* | 750 EC | Fenpropidin | 100 | 134 |
| 3 | Pulsor 240 SC | 240 SC | Thifluzamide | 120 | 500 |
| | ADAFF0103/17* | 750 EC | Fenpropidin | 200 | 267 |
| 4 | Oranis | 250 SC | Picoxystrobin | 60 | 240 |
| | ADAFF0103/17* | 750 EC | Fenpropidin | 100 | 134 |
| 5 | Oranis | 250 SC | Picoxystrobin | 60 | 240 |
| | ADAFF0103/17* | 750 EC | Fenpropidin | 200 | 267 |
| 6 | Unizeb Gold | 750 WG | Mancozeb | 1125 | 1500 |
| | ADAFF0103/17* | 750 EC | Fenpropidin | 100 | 134 |
| 7 | Unizeb Gold | 750 WG | Mancozeb | 1125 | 1500 |
| | ADAFF0103/17* | 750 EC | Fenpropidin | 200 | 267 |
| 8 | Funginil | 500 SC | Chlorothalonil | 1000 | 2000 |
| | ADAFF0103/17* | 750 EC | Fenpropidin | 100 | 134 |
| 9 | Funginil | 500 SC | Chlorothalonil | 1000 | 2000 |
| | ADAFF0103/17* | 750 EC | Fenpropidin | 200 | 267 |

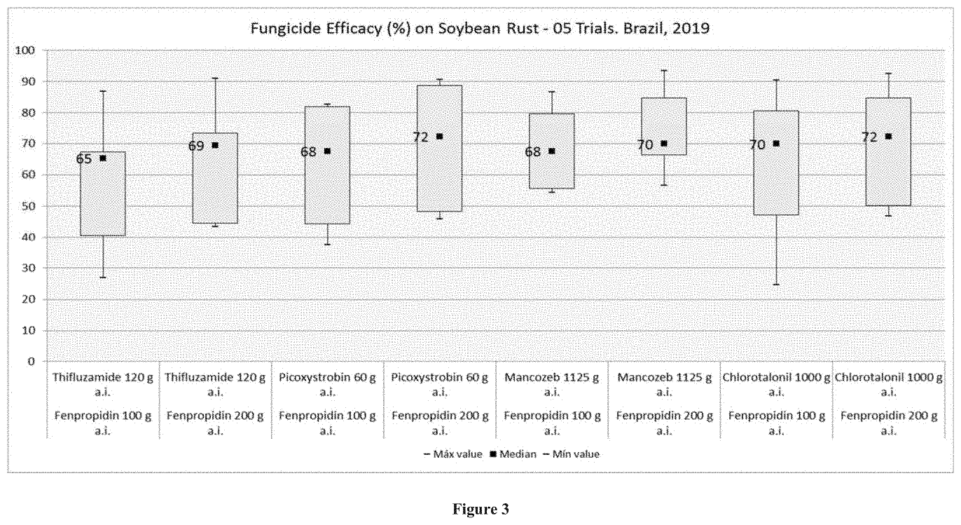

The efficacy of the combinations for controlling soybean rust is shown in FIG. 3.

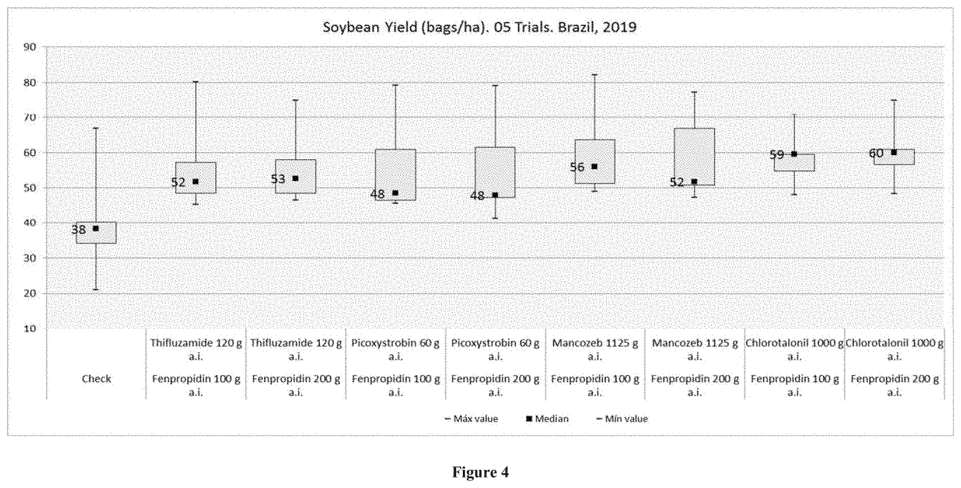

The efficacy of the combinations for improving yield is shown in FIG. 4.

### Example 8—Efficacy Assessment of Combinations of Fenpropidin and Two Additional Fungicides

Combinations of fenpropidin and two additional fungicides were evaluated for their efficacy in controlling soybean rust and improving crop yield.

The combinations tested and their application rates are summarized in Table 14 below.

TABLE 14

| | | | | | Rate |
|---|---|---|---|---|---|
| N. | Product | Formulation | A.I. | g a.i./ha | (mL or g/ha) |
| 1 | Untreated | — | — | — | — |
| 2 | Oranis | 250 SC | Picoxystrobin | 60 | 240 |
| | ADAFF0103/17 | 750 EC | Fenpropidin | 100 | 134 |
| | Unizeb Gold* | 750 WG | Mancozeb | 1125 | 1500 |
| 3 | Oranis | 250 SC | Picoxystrobin | 60 | 240 |
| | ADAFF0103/17 | 750 EC | Fenpropidin | 200 | 267 |
| | Unizeb Gold* | 750 WG | Mancozeb | 1125 | 1500 |
| 4 | Oranis | 250 SC | Picoxystrobin | 60 | 240 |
| | ADAFF0103/17 | 750 EC | Fenpropidin | 100 | 134 |
| | Funginil * | 500 SC | Chlorotalonil | 1000 | 2000 |
| 5 | Oranis | 250 SC | Picoxystrobin | 60 | 240 |
| | ADAFF0103/17 | 750 EC | Fenpropidin | 200 | 267 |
| | Funginil * | 500 SC | Chlorotalonil | 1000 | 2000 |
| 6 | ADM.3500.F.2.A | 250 EC | Prothioconazole | 80 | 320 |
| | ADAFF0103/17 | 750 EC | Fenpropidin | 100 | 134 |
| | Unizeb Gold* | 750 WG | Mancozeb | 1125 | 1500 |
| 7 | ADM.3500.F.2.A | 250 EC | Prothioconazole | 80 | 320 |
| | ADAFF0103/17 | 750 EC | Fenpropidin | 200 | 267 |
| | Unizeb Gold* | 750 WG | Mancozeb | 1125 | 1500 |
| 8 | ADM.3500.F.2.A | 250 EC | Prothioconazole | 80 | 320 |
| | ADAFF0103/17 | 750 EC | Fenpropidin | 100 | 134 |
| | Funginil * | 500 SC | Chlorothalonil | 1000 | 2000 |
| 9 | ADM.3500.F.2.A | 250 EC | Prothioconazole | 80 | 320 |
| | ADAFF0103/17 | 750 EC | Fenpropidin | 200 | 267 |
| | Funginil * | 500 SC | Chlorothalonil | 1000 | 2000 |
| 10 | ADM.3500.F.2.A | 250 EC | Prothioconazole | 80 | 320 |
| | ADAFF0103/17 | 750 EC | Fenpropidin | 100 | 134 |
| | Oranis * | 250 SC | Picoxystrobin | 60 | 240 |
| 11 | ADM.3500.F.2.A | 250 EC | Prothioconazole | 80 | 320 |
| | ADAFF0103/17 | 750 EC | Fenpropidin | 200 | 267 |
| | Oranis * | 250 SC | Picoxystrobin | 60 | 240 |

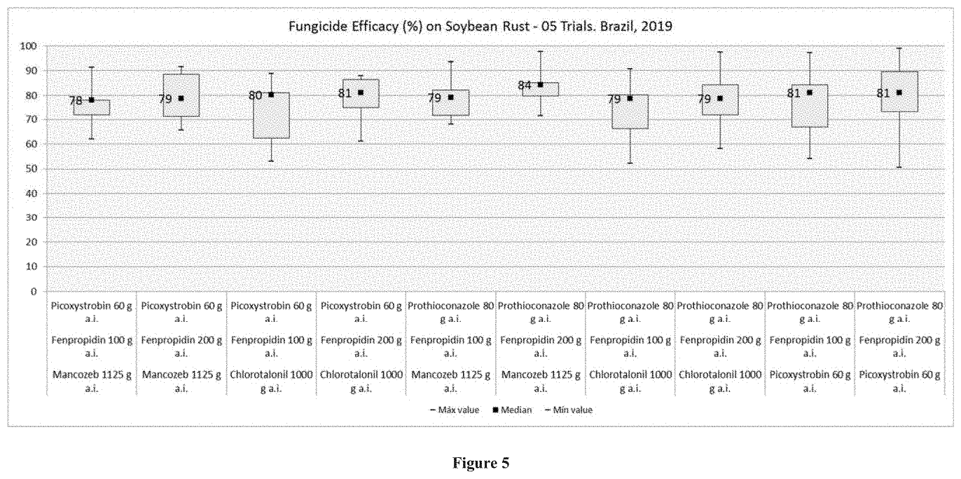

The efficacy of the combinations for controlling soybean rust is shown in FIG. 5.

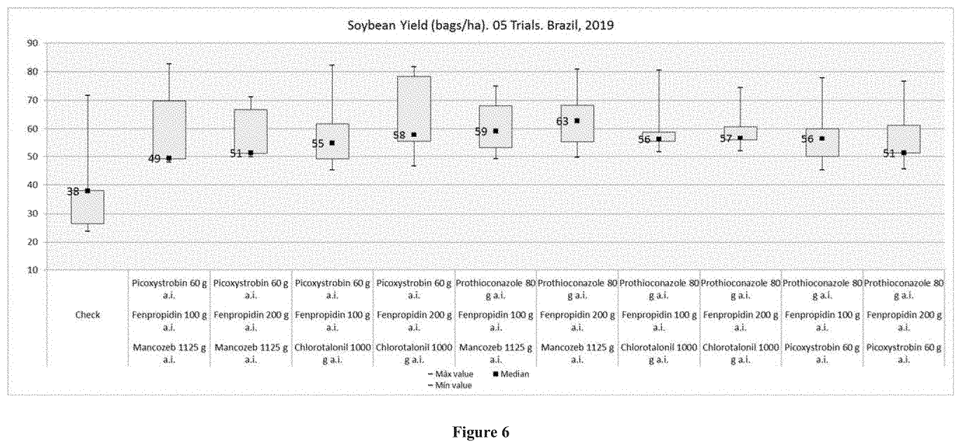

The efficacy of the combinations for improving yield is shown in FIG. 6.

### Example 9: Efficacy of Fenpropidin Mixtures for Powdery Mildew in Grapevines

The experiments for fungicide tests for the control of powdery mildew (Erysiphe necator) in grapevines cv. Semillon were carried out at At Busselton, in the Geographe grape region of Western Australia in 2018-19. Each plot consisted of at least 19.8 m². The experimental design was a randomized complete block design with four replicates. Four applications of foliar treatments were carried out at 11 to 20-day intervals, depending on the powdery mildew pressure. The applications were made with ATV005 sprayer, 631-2020 L/ha of spray volume and solid cone nozzle type at size of D5DC56 per nozzle, mix size 15 L.

Results are shown in Table 15 below.

TABLE 15

| | | | | % control observed | | |
|---|---|---|---|---|---|---|
| | | | | Leaves 154 days | | |
| | | | | after first | | |
| | | | Application | application and 105 | | |
| | | Fungicide | rate g ai | after second | % control | Colby Ratio |
| Product Name | AI | family | per 100 L | application | expecetd | o/e |
| ADM 1700F .A. 1 | Fenpropidin | Piperidines | 30 | 23.70 | | |
| Vivando | Metrafenone | Unknow | 10 | 31.00 | | |
| | | mode of | | | | |
| | | action | | | | |
| ADM 1700F .A. 1 + | Fenpropidin + | | 30 + 10 | 56.90 | 47.35 | 1.20 |
| Vivando | Metrafenone | | | | | |
| ADM 1700F .A. 1 | Fenpropidin | Piperidines | 30 | 23.7 | | |
| Flute | Cyflufenamid | Unknow | 1.25 | 22.9 | | |
| | | mode of | | | | |
| | | action | | | | |
| ADM 1700F .A. 1 + | Fenpropidin + | | 30 + 1.25 | 43.3 | 41.1727 | 1.05 |
| Flute | Cyflufenamid | | | | | |
| ADM 1700F .A. 1 | Fenpropidin | Piperidines | 30 | 23.7 | | |
| Nimrod | Bupirimate | Pyrimidines | 15 | 17.7 | | |
| ADM 1700F .A. 1 + | Fenpropidin + | | 30 + 15 | 22.5 | 37.2051 | 0.60 |
| Nimrod | Bupirimate | | | | | |
| ADM 1700F .A. 1 | Fenpropidin | Piperidines | 30 | 23.7 | | |
| Diger | Difenoconazole | Triazoles | 6.25 | 57.8 | | |
| ADM 1700F .A. 1 + | Fenpropidin + | | 30 + 6.25 | 68.3 | 67.8014 | 1.01 |
| Diger | Difenoconazole | | | | | |

### Example 10: Efficacy of Fenpropidin Mixtures for Powdery Mildew and Black Spot in Apple

The experiments for fungicide tests for the control of Powdery mildew caused by Podosphaera leucotricha and Black spot (apple scab) caused by the fungus Venturia inaequalis, also developed in the trial were carried out near Orange on the Central Tablelands region of New South Wales, Australia. Each plot consisted 1 tree. The experimental design was a randomized complete block design with four replicates. Four applications of foliar treatments were carried out at 14 to 21-days intervals, with the first application when the fruits were 20-30 mm in diameter. Treatments were applied using a motorised pump and hand gun incorporating one GG 3009 solid cone nozzle. Treatments were applied in a total volume of between 1600-2000 L/ha using a pressure of 1500 kPa and a coarse spray. At each assessment, 100 leaves and fruit were examined for symptoms of powdery mildew and black spot/apple scab. The number of leaves and fruit with symptoms were recorded and the severity of symptoms rated using a 0-10 scale where 0=no symptoms, 5=50% of leaf/fruit area with symptoms and 10=100% of leaf/fruit area with symptoms. Results are presented as the percentage of leaves or fruit with symptoms and a mean powdery mildew or black spot/apple scab severity rating with a maximum of 1000 (eg 100 leaves assessed each with a severity rating of 10).

Results for mildew in apple are shown in Table 16 below.

TABLE 16

| | | | | % control | | |
|---|---|---|---|---|---|---|
| | | | | observed | | |
| | | | Application | Leaves 17 DAYS | | |
| | | Fungicide | rate g ai | after last | % control | Colby Ratio |
| Product Name | AI | family | per 100 L | application | expecetd | o/e |
| ADM 1700F .A. 1 | Fenpropidin | Piperidines | 30 | 86 | | |
| Fontelis | Penthiopyrad | SDHI | 15 | 78 | | |
| ADM 1700F .A. 1 + | Fenpropidin + | | 30 + 15 | 84 | 78 | 1.08 |
| Fontelis | Penthiopyrad | | | | | |
| ADM 1700F .A. 1 | Fenpropidin | Piperidines | 30 | 86 | | |
| Nimrod | Bupirimate | Pyrimidines | 15 | 75 | | |
| ADM 1700F .A. 1 + | Fenpropidin + | | 30 + 15 | 82 | 75 | 1.09 |
| Nimrod | Bupirimate | | | | | |

Results for black spot in apple is shown in Table 17 below.

TABLE 17

| | | | | % control | | |
|---|---|---|---|---|---|---|
| | | | | observed | | |
| | | | Application | Leaves 17 DAYS | | |
| | | Fungicide | rate g ai | after last | % control | Colby Ratio |
| Product Name | AI | family | per 100 L | application | expecetd | o/e |
| ADM 1700F .A. 1 | Fenpropidin | Piperidines | 30 | 89 | | |
| Fontelis | Penthiopyrad | SDHI | 15 | 87 | | |
| ADM 1700F .A. 1 + | Fenpropidin + | | 30 + 15 | 90 | 87 | 1.03 |
| Fontelis | Penthiopyrad | | | | | |
| ADM 1700F .A. 1 | Fenpropidin | Piperidines | 30 | 89 | | |
| Bogard | Cyflufenamid | Unknow mode | 5 | 85 | | |
| | | of action | | | | |
| ADM 1700F .A. 1 + | Fenpropidin + | | 30 + 5 | 90 | 85 | 1.06 |
| Bogard | Cyflufenamid | | | | | |

### Example 11: Efficacy of Fenpropidin Mixtures for Powdery Mildew in Zucchini

The experiments for fungicide tests for the control of Powdery mildew caused by Podosphaera xanthii were carried out ay Bowen, North Queensland, Australia. Each plot consisted of at least 6 m×1.5 m. The experimental design was a randomized complete block design with four replicates. Three treatments were applied as a foliar spray at the first sign of infection and followed up with an additional spray at a 10-day interval. Treatments were applied using a compressed air knapsack sprayer with handheld spray boom. The nozzles used was AITTJ 60 110 02 yellow. Treatments were applied in a total volume of 500 L/ha using a pressure of 300 kPa, spaced 0.5 m/sec. Powdery mildew was assessed from the underside of mature leaves, with 20 randomly sampled leaves (subsamples) assessed per plot at each assessment timing. Leaves were rated for severity of infection as a visual percentage of leaf area infected with active powdery mildew spores. Percentage incidence of infection was calculated from severity data.

Results are shown in Table 18 below.

TABLE 18

| | | | | % control | | |
|---|---|---|---|---|---|---|
| | | | | observed | | |
| | | | | Leaves 10 DAYS | | |
| | | Fungicide | Application | after first | % control | Colby Ratio |
| Product Name | AI | family | rate g ai/ha | application | expecetd | o/e |
| ADM 1700F .A. 1 | Fenpropidin | Piperidines | 300 | 68 | | |
| Vivando | Metrafenone | Unknow mode | 100 | 20 | | |
| | | of action | | | | |
| ADM 1700F .A. 1 + | Fenpropidin + | | 300 + 100 | 82 | 38.96 | 2.10 |
| Vivando | Metrafenone | | | | | |
| ADM 1700F .A. 1 | Fenpropidin | Piperidines | 300 | 68 | | |
| Nimrod | Bupirimate | Pyrimidines | 150 | 60 | | |
| ADM 1700F .A. 1 + | Fenpropidin + | | 300 + 100 | 81 | 69.48 | 1.17 |
| Nimrod | Bupirimate | | | | | |
| ADM 1700F .A. 1 | Fenpropidin | Piperidines | 300 | 68 | | |
| Flute | Cyflufenamid | Unknow mode | 12.5 | 40 | | |
| | | of action | | | | |
| ADM 1700F .A. 1 + | Fenpropidin + | | 300 + 12.5 | 89 | 54.22 | 1.64 |
| Flute | Cyflufenamid | | | | | |
| ADM 1700F .A. 1 | Fenpropidin | Piperidines | 300 | 68 | | |
| Score | Difenoconazole | Triazoles | 125 | 54 | | |
| ADM 1700F .A. 1 + | Fenpropidin + | | 300 + 125 | 95 | 64.902 | 1.46 |
| Score | Difenoconazole | | | | | |

The present inventive concept has been described in terms of exemplary principles and embodiments, but those skilled in the art will recognize that variations may be made and equivalents substituted for what is described without departing from the scope and spirit of the disclosure as defined by the following claims.

What is claimed is:

1. (canceled)

2. A combination comprising (a) an amount of fenpropidin, and an amount of at least one additional fungicide selected from the group consisting of:
(b) a multi-site contact fungicide,
(c) a strobilurin fungicide,
(d) a succinate dehydrogenase inhibitor (SDHI) fungicide,
(e) a triazole fungicide,
(f) a dicarboxamide fungicide,
(g) a phenylpyrrole (PP) fungicide,
(h) a benzophenone fungicide,
(i) a phenyl acetamide fungicide, and
(j) a pyrimidines fungicide,
wherein the combination is more effective for treating a plant or soil against fungal infection than when each fungicide at the same amount is applied alone.

3-4. (canceled)

5. The combination of claim 2, wherein:
(a) the multi-site contact fungicide is selected from copper, copper oxychloride, copper hydroxide, sulfur, anilazine, dithianon, captan, captafol, folpet, febram, mancozeb, zinc thiazole, chlorothalonil, maneb, propineb, metiram, thiram, zineb, ziram, and any mixture thereof,
(b) the strobilurin fungicide is selected from azoxystrobin, kresoxim-methyl, picoxystrobin, fluxastrobin, oryzastrobin, dimoxystrobin, pyraclostrobin and trifloxystrobin, enoxastrobin, pyraclostrobin, mandestrobin, flufenostrin, coumoxystrobin, metominostrobin, fenaminstrobin, pyrametostrobin, and any mixture thereof,
(c) the SDHI fungicide is selected from fluxapyroxad, penflufen, furametpyr, bixafen, isopyrazam, sedaxane, benzovindiflupyr, thifluzamide, isofetamid, fluopyram, pydiflumetofen, pyraziflumid, benodanil, mepronil, flutolanil, fenfuram, oxycarboxin, carboxin, boscalid, quinofumelin, fluindapyr, and any mixture thereof,
(d) the triazole fungicide is selected from azaconazole, etaconazole, ipconazole, tebuconazole, metconazole, fenbuconazole, bitertanol, bromuconazole, fluquinconazole, myclobutanil, tetraconazole, flusilazole, cyproconazole, flutriafol, penconazole, triadimenol, difenoconazole, hexaconazole, simeconazole, prothioconazole, imibenconazole, diniconazole, epoxiconazole, and any mixture thereof,
(e) the dicarboximide fungicide is selected from the group consisting of vinclozolin, iprodione, procymidone, chlozolinate, and any mixture thereof,
(f) the PP fungicide is selected from the group consisting of fenpiclonil, fludioxonil and a mixture thereof,
(g) the benzophenone fungicide is metraphenone,
(h) the phenyl acetamide fungicide is cyflufenamid, and/or
(i) the pyrimidines fungicide is bupirimate.

6. The combination of claim 2, wherein:
(a) the multi-site contact fungicide is selected from mancozeb, copper, copper oxychloride, copper hydroxide, chlorothalonil, captan, folpet, fluazinam and any mixture thereof,
(b) the strobilurin fungicide is picoxystrobin, azoxystrobin, or any mixture thereof,
(c) the SDHI fungicide is fluxapyroxad, bixafen, benzovindiflupyr, boscalid, thifluzamide, or any mixture thereof,
(d) the triazole fungicide is prothioconazole, difenoconazole, hexaconazole, tebuconazole, tetraconazole, or any mixture thereof,
(e) the dicarboximide fungicide is iprodione, and/or
(f) the PP fungicide is fludioxonil.

7-19. (canceled)

20. The combination of claim 2, wherein the combination comprises fenpropidin and one additional fungicide.

21. The combination of claim 20, wherein:
a. the combination comprises a multi-site contact fungicide and the weight ratio of fenpropidin to the multi-site contact fungicide is from 1:25 to 8:5,
b. the combination comprises a SDHI fungicide and the weight ratio of fenpropidin to the SDHI fungicide is 2:1 to 5:1,
c. the combination comprises a triazole fungicide and the weight ratio of fenpropidin to the triazole fungicide is 2:5 to 16:1,
d. the combination comprises a dicarboximide fungicide and the weight ratio of fenpropidin to the dicarboximide fungicide is 2-4:5,
e. the combination comprises a PP fungicide and the weight ratio of fenpropidin to the PP fungicide is 2-4:5,
f. the combination comprises a benzophenone fungicide and the weight ratio of fenpropidin to the benzophenone fungicide is 2-4:5,
g. the combination comprises a phenyl acetamide fungicide and the weight ratio of fenpropidin to the phenyl acetamide fungicide is 2-4:5, and/or
h. the combination comprises a pyrimidines fungicide and the weight ratio of fenpropidin to the pyrimidines fungicide is 2-4:5.

22. The combination of claim 20, wherein the combination comprises:
a. fenpropidin and mancozeb,
b. fenpropidin and chlorothalonil,
c. fenpropidin and copper oxychloride,
d. fenpropidin and copper hydroxide,
e. fenpropidin and fluazinam,
f. fenpropidin and captan,
g. fenpropidin and folpet,
h. fenpropidin and fluxapyroxad,
i. fenpropidin and bixafen,
j. fenpropidin and benzovindiflupyr,
k. fenpropidin and boscalid,
l. fenpropidin and thifluzamide,
m. fenpropidin and picoxystrobin,
n. fenpropidin and azoxystrobin,
o. fenpropidin and prothioconazole,
p. fenpropidin and hexaconazole,
q. fenpropidin and tebuconazole,
r. fenpropidin and tetraconazole,
s. fenpropidin and iprodione,
t. fenpropidin and fludioxonil,
u. fenpropidine and metraphenone,
v. fenpropidine and cyflufenamid, or
w. fenpropidin and bupirimate.

23. The combination of claim 2, wherein the combination comprises fenpropidin and two additional fungicides.

24. The combination of claim 23, wherein:
a. the combination comprises fenpropidin, a multi-site contact fungicide and a SDHI fungicide, and the weight ratio of fenpropidin to the multi-site contact fungicide to the SDHI fungicide is 2-10:20-60:1:3,
b. the combination comprises fenpropidin, a multi-site contact fungicide and a strobilurin fungicide, and the weight ratio of fenpropidin to the multi-site contact fungicide to the strobilurin fungicide is 5:50-30-3:2,
c. the combination comprises fenpropidin, a multi-site contact fungicide and a triazole fungicide, and the weight ratio of fenpropidin to the multi-site contact fungicide to the triazole fungicide is 2-5:20-30:1:2,
d. the combination comprises fenpropidin, a multi-site contact fungicide and a triazole fungicide, and the weight ratio of fenpropidin to the multi-site contact fungicide to the triazole fungicide is 4-8:40-48:3-5,
e. the combination comprises fenpropidin, a first multi-site contact fungicide and a second multi-site contact fungicide, and the weight ratio of fenpropidin to the first multi-site contact fungicide to the second multi-site contact fungicide is 2-20:20-125:1-6,
f. the combination comprises fenpropidin, a multi-site contact fungicide and a SDHI fungicide, and the weight ratio of fenpropidin to the multi-site contact fungicide to the SDHI fungicide is 5-20:50-125: 3-8,
g. the combination comprises fenpropidin, a multi-site contact fungicide and a strobilurin fungicide, and the weight ratio of fenpropidin to the multi-site contact fungicide to the strobilurin fungicide is 5-20:50-125:3-8,
h. the combination comprises fenpropidin, a multi-site contact fungicide and a strobilurin fungicide, wherein the weight ratio of fenpropidin to the multi-site contact fungicide to the strobilurin fungicide is 10:5-3:6-3,
i. the combination comprises fenpropidin, a SDHI fungicide and a triazole fungicide, wherein the weight ratio of fenpropidin to the SDHI fungicide to the triazole fungicide is 2-10:1-3:1-4,
j. the combination comprises fenpropidin, a triazole fungicide and a strobilurin fungicide, wherein the weight ratio of fenpropidin to the triazole fungicide to the strobilurin fungicide is 10-5:5-2:6-2,
k. the combination comprises fenpropidin, a triazole fungicide and a strobilurin fungicide and the weight ratio of fenpropidin to the triazole fungicide to the strobilurin fungicide is 20-40:15-25:12-60,
l. the combination comprises fenpropidin, a strobilurin fungicide and a multi-site contact-fungicide, and the weight ratio of fenpropidin to the strobilurin fungicide to the multi-site contact fungicide is 5-10:3-2:25,
m. the combination comprises fenpropidin, a SDHI fungicide and a multi-site contact fungicide, and the weight ratio of fenpropidin to the SDHI fungicide to the multi-site contact fungicide is 2-10:1-2:5-25,
n. the combination comprises fenpropidin, a strobilurin fungicide and a multi-site contact fungicide, and the weight ratio of fenpropidin to the strobilurin fungicide to the multi-site contact fungicide is 10:6-2:25,
o. the combination comprises fenpropidin, a SDHI fungicide and a multi-site contact fungicide, and the weight ratio of fenpropidin to the SDHI fungicide to the multi-site contact fungicide is 2-10:1-2:5-25,
p. the combination comprises fenpropidin, a triazole fungicide and a multi-site contact fungicide, and the weight ratio of fenpropidin to the triazole fungicide to the multi-site contact fungicide is 10-20:7-8:25-75,
q. the combination comprises fenpropidin, a triazole fungicide and a multi-site contact fungicide, and the weight ratio of fenpropidin to the triazole fungicide to the multi-site contact fungicide is 4-8:3-5:10-40,
r. the combination comprises fenpropidin, a strobilurin fungicide and a SDHI fungicide, and the weight ratio of fenpropidin to the strobilurin fungicide to the SDHI fungicide is 20-40:12-8:15-9, or
s. the combination comprises fenpropidin, a multi-site contact fungicide and a SDHI fungicide, and the weight ratio of fenpropidin to the multi-site contact fungicide to the SDHI fungicide is 4-40:20-100:3-9.

25. The combination of claim 23, wherein the combination comprises:
a. fenpropidin, mancozeb and fluxapyroxad,
b. fenpropidin, mancozeb and picoxystrobin,
c. fenpropidin, mancozeb and azoxystrobin,
d. fenpropidin, mancozeb and prothioconazole,
e. fenpropidin, mancozeb and tebuconazole,
f. fenpropidin, chlorothalonil and fluxapyroxad,
g. fenpropidin, chlorothalonil and azoxystrobin,
h. fenpropidin, chlorothalonil and picoxystrobin,
i. fenpropidin, fluxapyroxad and picoxystrobin,
j. fenpropidin, fluxapyroxad and prothioconazole,
k. fenpropidin, prothioconazole and picoxystrobin,
l. fenpropidin, tebuconazole and picoxystrobin,
m. fenpropidin, picoxystrobin and copper oxychloride,
n. fenpropidin, azoxystrobin and copper oxychloride,
o. fenpropidin, fluxapyroxad, and copper oxychloride,
p. fenpropidin, azoxystrobin, and copper hydroxide,
q. fenpropidin, fluxapyroxad, and copper hydroxide,
r. fenpropidin, prothioconazole and copper hydroxide,
s. fenpropidin, tebuconazole and copper hydroxide,
t. fenpropidin, azoxystrobin and boscalid, or
u. fenpropidin, copper hydroxide and boscalid.

26. The combination of claim 2, wherein the combination comprises fenpropidin and three additional fungicides.

27. The combination of claim 26, wherein the combination comprises fenpropidin, mancozeb, tebuconazole and picoxystrobin.

28. The combination of claim 2, wherein:
(a) the amount of fenpropidin and the amount of the additional fungicide(s) are more effective for treating a plant or soil against fungal infection than when each fungicide at the same amount is applied alone,
(b) the amount of fenpropidin in the combination is less than the fungicidally effective amount of fenpropidin when fenpropidin is used alone, and/or
(c) the amount of the additional fungicide(s) in the mixture is less than the fungicidally effective amount of the additional fungicide(s) when the additional fungicide(s) is used alone.

29. (canceled)

30. A fungicidal composition comprising the combination of claim 2 and an agrochemically acceptable carrier.

31-36. (canceled)

37. A method of combatting phytopathogenic diseases on crop plants or treating a plant or soil against fungal infection, which comprises applying the combination of claim 2, wherein:
(a) the method is effective for combatting phytopathogenic diseases on the crop plant and the combination of claim 2 is applied to the crop plant or to the locus thereof, or
(b) the method is effective for treating the plant or soil against fungal infection and the combination of claim 2 is applied to the plant, propagation material of the plant, or soil.

38. (canceled)

39. A method of treating a plant or soil against fungal infection comprising applying to the plant, propagation material of the plant, or soil (a) an amount of fenpropidin, and an amount of at least one additional fungicide selected from the group consisting of:
(b) a multi-site contact fungicide,
(c) a strobilurin fungicide,
(d) a succinate dehydrogenase inhibitor (SDHI) fungicide,
(e) a triazole fungicide,
(f) a dicarboxamide fungicide,
(g) a phenylpyrrole (PP) fungicide,
(h) a benzophenone fungicide,
(i) a phenyl acetamide fungicide, and
(j) a pyrimidines fungicide,
so as to thereby treat the plant or soil against fungal infection,
wherein the amount of fenpropidin and the amount of the additional fungicide(s) when applied together is more effective for treating the plant or soil against fungal infection than when each fungicide at the same amount is applied alone.

40. The method of claim 39, wherein:
(a) fenpropidin is applied at a rate between 10-400 g a.i./ha, or at a rate of 300 g a.i./ha, 250 g a.i./ha, 200 g a.i./ha, 150 g a.i./ha, 100 g a.i./ha, or 75 g a.i./ha,
(b) the multi-site contact fungicide is applied at a rate of 100-2000 g a.i./ha,
(c) the SDHI fungicide is applied at a rate of 10-250 g a.i./ha,
(d) the strobilurin fungicide is applied at a rate of 10-130 g a.i./ha,
(e) the triazole fungicide is applied at a rate of 5-175 g a.i./ha,
(f) the dicarboximide fungicide is applied at a rate of 250-500 g a.i./ha,
(g) the PP fungicide is applied at a rate of 250-500 g a.i./ha,
(h) the benzophenone fungicide is applied at a rate of 50-150 g a.i./ha,
(i) the phenyl acetamide fungicide is applied at a rate of 1-50 g a.i./ha,
(j) the pyrimidines fungicide is applied at a rate of 50-200 g a.i./ha,
(k) (i) the fungus is Phakopsora pachyrhizi or the fungal disease is Asian soybean rust, (ii) the fungus is Erysiphe necator or the fungal disease is powdery mildew, (iii) the fungus is Podosphaera leucotricha or the fungal disease is powdery mildew, (iv) the fungus is Venturia inaequalis or the fungal disease is black spot, and/or (v) the fungus is Podosphaera xanthii or the fungal disease is powdery mildew, and/or
(l) the plant is soybean, dry bean, corn, cotton, canola, cereal, coffee, rice, pome fruit, grapevine, zucchini, or tomato.

41-45. (canceled)

46. A method of treating a plant or soil against Phakopsora pachyrhizi infection comprising applying an effective amount of fenpropidin to the plant, propagation material of the plant, or soil so as to thereby treat the plant or soil against Phakopsora pachyrhizi infection.

47. (canceled)

48. A package comprising the combination of claim 2.

49. (canceled)

50. The fungicidal composition of claim 30, wherein the composition comprises a combination of a) fenpropidin and at least one of the following fungicides:
(b) a multi-site contact fungicide;
(c) and/or a strobilurin fungicide;
(d) and/or a succinate dehydrogenase inhibitor (SDHI) fungicide;
(e) and/or a triazole fungicide.

51. The fungicidal composition of claim 50, wherein:
(a) the weight ratio of a) to b) and/or c) and/or d) and/or a) to e) lies in the range of from 10:1 to 1:10,
(b) the weight ratio of a) fenpropidin to b) and/or c) and/or d) and/or a) to e) lies in the range of from 5:1 to 1:5, and/or
(c) the combination of a) fenpropidin in association with b) and/or c) and/or d) and/or e) represents 0.5 percent by weight (wt %) to 95 percent by weight (wt %) of the total weight of the fungicide composition.
